(19) United States
(12) Patent Application Publication
(10) Pub. No.: US 2025/0253589 A1
(43) Pub. Date: Aug. 7, 2025

(54) CONNECTOR SET

(71) Applicant: Panasonic Intellectual Property Management Co., Ltd., Osaka (JP)

(72) Inventors: TAKASHI KOZAKI, Mie (JP); RYOSUKE SHIMOMURA, Mie (JP); YUKI MINAI, Mie (JP)

(21) Appl. No.: 19/014,476

(22) Filed: Jan. 9, 2025

(30) Foreign Application Priority Data
Feb. 5, 2024 (JP) 2024-015896

(51) Int. Cl. H01R 13/6581; H01R 12/71

(52) U.S. Cl. CPC H01R 13/6581; H01R 12/716

(57) ABSTRACT

A connector set includes a connector and a mating connector. The connector has an outer shield that surrounds a first terminal and is held by a housing. The mating connector includes a mating outer shield that surrounds a first mating terminal and is held by a mating housing. A first outer shield of the outer shield includes a recess recessed outward of the connector, and an insertion part disposed above the recess and continuous with an upper surface of the recess. A first mating outer shield of the mating outer shield is recessed inward of the mating connector, and includes a mating recess in which the insertion part is disposed in a connected state where the connector and the mating connector are connected, and a mating insertion part disposed below the mating recess and disposed in the recess in the connected state.

### BACKGROUND

### 1. Technical Field

The present disclosure relates generally to a connector set, and more particularly, to a connector set including a connector and a mating connector.

### 2. Description of the Related Art

PTL 1 discloses a connector device including a connector and a mating connector.

The connector includes a terminal, a housing that holds the terminal, and an outer shield that surrounds the terminal. The mating connector includes a mating terminal, a housing that holds the mating terminal, and an outer shield that surrounds the mating terminal. The connector and the mating connector are connected to each other by at least one moving in an upper-lower direction toward the other.

### Citation List

Patent Literature
PTL 1: Unexamined Japanese Patent Publication No. 2021-111598

### SUMMARY

In a connector set such as the connector device described in PTL 1, it is desired to improve a removal force.

A connector set according to an aspect of the present disclosure includes a connector and a mating connector. The connector is connected to the mating connector by moving upward relative to the mating connector. The connector includes a housing, a plurality of terminals, and an outer shield. The plurality of terminals are held by the housing. The plurality of terminals include a first terminal. The outer shield is held by the housing. The outer shield surrounds the first terminal. The mating connector includes a mating housing, a plurality of mating terminals, and a mating outer shield. The plurality of mating terminals are held by the mating housing. The plurality of mating terminals are electrically connected to the plurality of terminals. The plurality of mating terminals include a first mating terminal electrically connected to the first terminal. The mating outer shield is held by the mating housing. The outer shield includes a first outer shield facing the first terminal in a left-right direction. The mating outer shield includes a first mating outer shield facing the first mating terminal in the left-right direction. The first outer shield includes a recess recessed outward of the connector in the left-right direction, and an insertion part disposed above the recess and continuous with an upper surface of the recess. The first mating outer shield includes a mating recess that is recessed inward of the mating connector in the left-right direction, the insertion part being disposed in the mating recess in a connected state where the connector and the mating connector are connected, and a mating insertion part that is disposed below the mating recess and is disposed in the recess in the connected state.

According to the present disclosure, there is an advantage that the removal force can be improved.

### BRIEF DESCRIPTION OF THE DRAWINGS

FIG. 1 is a perspective view of a connector set according to an exemplary embodiment of the present disclosure in a connected state where a connector and a mating connector are connected as viewed from above;

FIG. 2 is a perspective view of the connector set in a disconnected state where the connector and the mating connector are separated as viewed from above;

FIG. 3 is an exploded perspective view of the connector as viewed from above;

FIG. 4 is a top view of the connector;

FIG. 5 is a bottom view of the connector;

FIG. 6 is a sectional view of an outer shield included in the connector and a mating outer shield included in the mating connector;

FIG. 7 is a perspective view of the mating connector as viewed from below;

FIG. 8 is an exploded perspective view of the mating connector as viewed from below;

FIG. 9 is a bottom view of the mating connector;

FIG. 10 is a top view of the mating connector;

FIG. 11 is a top view of the connector set in a connected state;

FIG. 12 is a sectional view of a portion corresponding to line XIII-XIII of FIG. 11 in a disconnected state of the connector set;

FIG. 13 is a sectional view taken along a line XIII-XIII in FIG. 11 in the connected state of the connector set;

FIG. 14 is a sectional view of a portion corresponding to line XVI-XVI in FIG. 11 in the disconnected state of the connector set;

FIG. 15 is a sectional view of a portion corresponding to line XVI-XVI in FIG. 11 in a state in the middle of transition from the disconnected state to the connected state of the connector set;

FIG. 16 is a sectional view taken along line XVI-XVI of FIG. 11 in the connected state of the connector set;

FIG. 17 is a sectional view of a portion corresponding to line XVIII-XVIII in FIG. 11 in a disconnected state of the connector set;

FIG. 18 is a sectional view taken along a line XVIII-XVIII in FIG. 11 in the connected state of the connector set;

FIG. 19 is a sectional view of a portion corresponding to line XX-XX in FIG. 11 in the disconnected state of the connector set;

FIG. 20 is a sectional view taken along line XX-XX of FIG. 11 in the connected state of the connector set;

FIG. 21 is a sectional view of a portion corresponding to line XXII-XXII of FIG. 11 in the disconnected state of the connector set;

FIG. 22 is a sectional view taken along line XXII-XXII in FIG. 11 in the connected state of the connector set; and

FIG. 23 is a sectional view of a main part of a connector set according to a modification in a disconnected state.

### DETAILED DESCRIPTIONS

Hereinafter, a connector, a mating connector, and a connector set according to an exemplary embodiment of the present disclosure will be described with reference to the accompanying drawings. The following exemplary embodiment is merely one of various exemplary embodiments of the present disclosure. The following exemplary embodiment can be variously changed in accordance with factors such as a design, as long as the object of the present disclosure can be achieved. The drawings described in the following exemplary embodiment are schematic representations, and ratios of sizes and thicknesses of components in the drawings do not necessarily need to reflect actual dimensional ratio.

### (1) Exemplary Embodiment

### (1.1) Overview of Connector Set

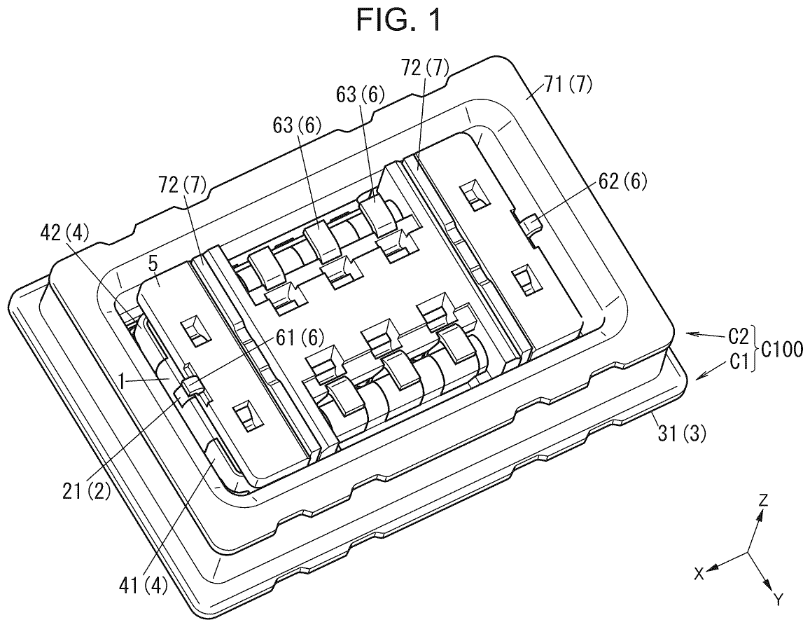

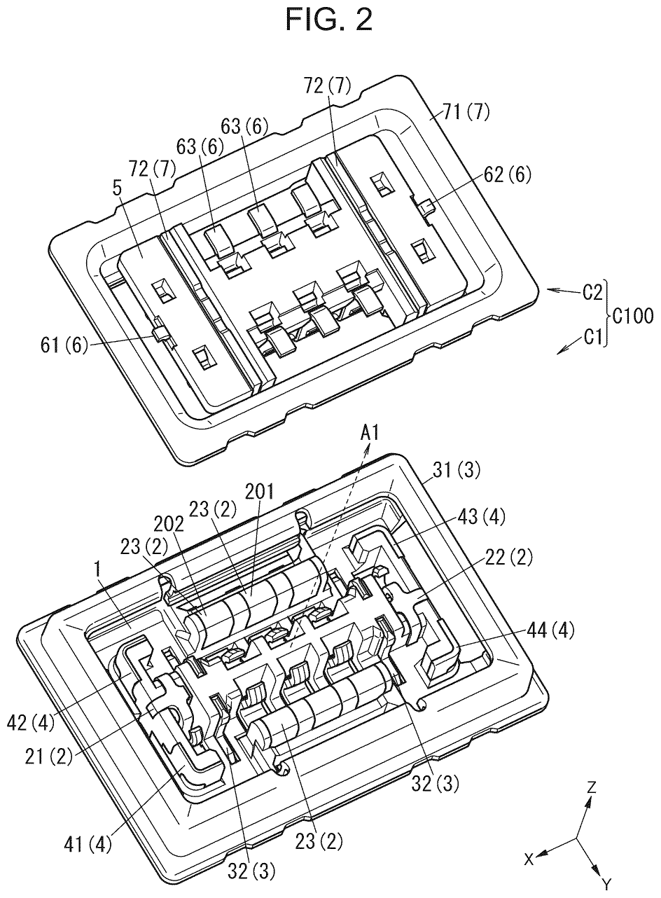

As illustrated in FIGS. 1 and 2, connector set C100 of the present exemplary embodiment includes connector C1 (socket) and mating connector C2 (header) connected to connector C1.

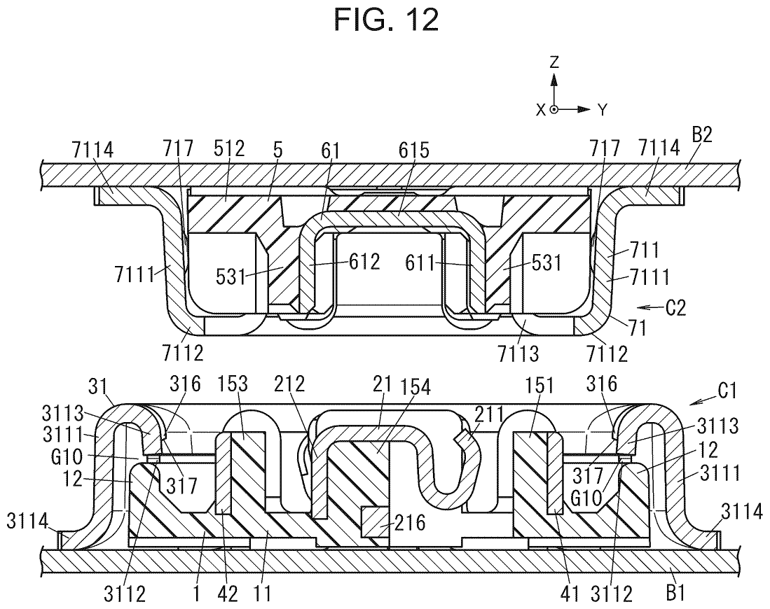

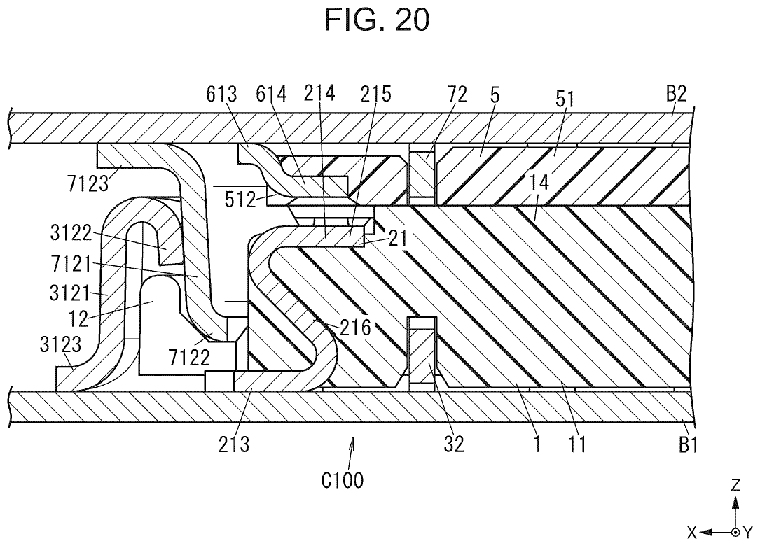

Connector set C100 is used, for example, to electrically connect a plurality of boards together incorporated in a mobile terminal such as a smartphone. Connector C1 is attached to circuit board B1 (see FIGS. 12 to 22). Mating connector C2 is attached to mating circuit board B2 (see FIGS. 12 to 22). Connector set C100 mechanically and electrically connects circuit board B1 and mating circuit board B2 by connecting connector C1 and mating connector C2 to each other. Connector set C100 may be used for an electronic device other than the mobile terminal, such as a camera module. Connector set C100 may be used to electrically connect a plurality of components together, such as a board and a display, and a board and a battery, other than electrically connecting the plurality of boards together.

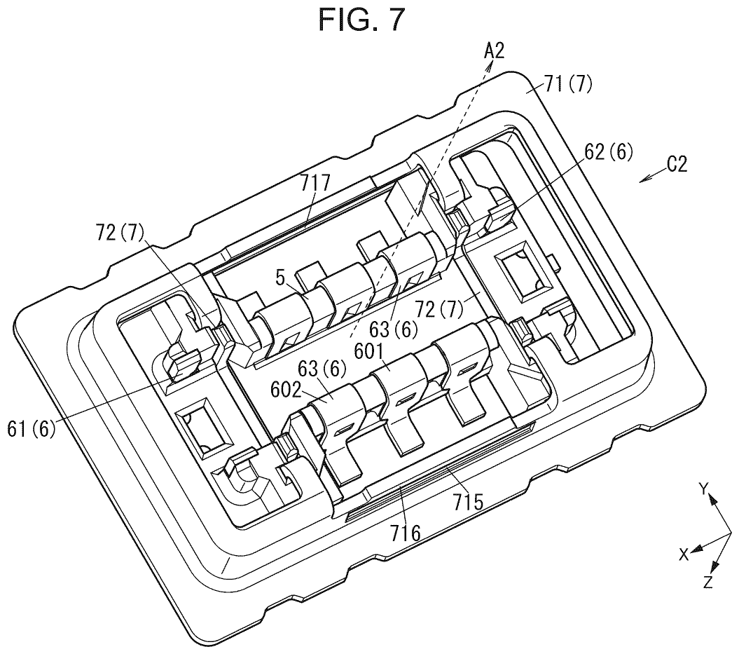

As illustrated in FIG. 2, connector C1 has a substantially rectangular parallelepiped shape having a width, a length, and a thickness. As illustrated in FIG. 7, mating connector C2 has a substantially rectangular parallelepiped shape having a width, a length, and a thickness. As illustrated in FIG. 2, connector C1 is connected to mating connector C2 from one side in one direction. In a connected state where connector C1 and mating connector C2 are connected (see FIG. 1), connector set C100 has a substantially rectangular parallelepiped shape having a width, a length, and a thickness.

Hereinafter, for the sake of convenience, in the connected state illustrated in FIG. 1, three axes (X-axis, Y-axis, and Z-axis) of a right-handed three-dimensional orthogonal coordinate system will be defined and described as follows with respect to connector set C100. That is, a direction along the thickness of connector set C100 that is a direction in which connector C1 and mating connector C2 face each other when connector C1 and mating connector C2 are connected is defined as a Z-axis direction. A direction orthogonal to the Z-axis direction and along the length of connector set C100 is defined as an X-axis direction. A direction orthogonal to both the X-axis direction and the Z-axis direction and along the width of connector set C100 is defined as a Y-axis direction. For the sake of convenience in description, the Z-axis direction is defined as an upper-lower direction, a side where mating connector C2 is positioned with respect to connector C1 (positive orientation of the Z-axis) is defined as “upper”, and the opposite orientation is defined as “lower”. The X-axis direction is defined as a front-rear direction, a positive orientation of the X-axis is defined as “front”, and the opposite orientation is defined as “rear”. The Y-axis direction is defined as a left-right direction, a positive orientation of the Y-axis is defined as “left”, and the opposite orientation is defined as “right”. However, the definition of the axis and direction in the present disclosure merely indicates a relative positional relationship between the members of connector set C100, and does not limit the orientation of connector set C100 at the time of use or the like. A dimension of connector set C100 in the front-rear direction (length direction) in the connected state is, for example, about several [mm].

### (1.2) Connector

As illustrated in FIGS. 2 to 5, connector C1 includes housing 1, a plurality of terminals 2, shield 3, and guard 4.

### (1.2.1) Housing

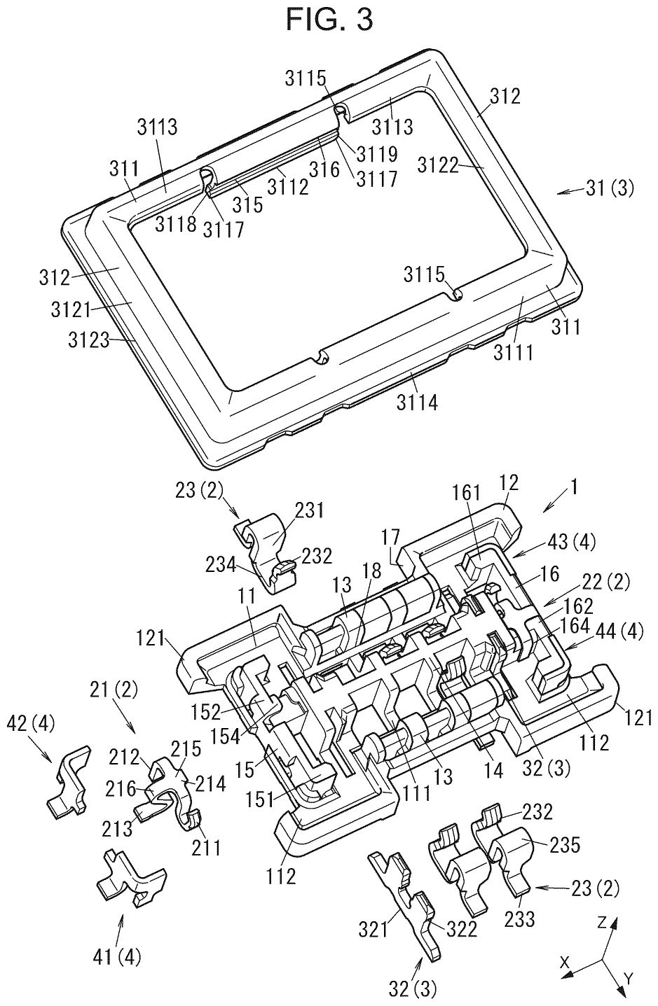

Housing 1 is made of an insulating resin material and is formed in a substantially flat rectangular parallelepiped shape long in the front-rear direction as illustrated in FIG. 3. Housing 1 has a two-fold rotationally symmetric shape around axis A1 (see FIG. 2) that passes through a center of housing 1 and is along the upper-lower direction. Housing 1 holds the plurality of terminals 2, shield 3, and guard 4.

As illustrated in FIG. 3, housing 1 integrally includes bottom wall 11, outer wall 12, a pair of side wall parts 13, central wall part 14, one end wall part (hereinafter, also referred to as “first end wall part”) 15, and another end wall part (hereinafter, also referred to as “second end wall part”) 16.

Bottom wall 11 has a plate shape whose thickness direction is along the upper-lower direction. Bottom wall 11 integrally includes inner bottom wall 111 and a pair of outer bottom walls 112.

Inner bottom wall 111 has a rectangular plate shape as viewed from above.

The pair of outer bottom walls 112 is connected to both front and rear ends of inner bottom wall 111. Each of the pair of outer bottom walls 112 has a rectangular shape as viewed from above, and has a plate shape whose dimension in the left-right direction is larger than a dimension of inner bottom wall 111. A center of the front end of outer bottom wall 112 on a front side is recessed rearward. A center of the rear end of outer bottom wall 112 on a rear side is recessed forward.

On left and right side surfaces of bottom wall 11, there is a step at a joint portion between inner bottom wall 111 and outer bottom wall 112. As a result, housing 1 has notch 17 at a center in the front-rear direction on both left and right side surfaces, and is formed in an H shape in top view.

Outer wall 12 protrudes upward from bottom wall 11. Outer wall 12 is provided at peripheral portions of the pair of outer bottom walls 112. Outer wall 12 has four partial wall parts 121 provided on four sides of bottom wall 11.

The pair of side wall parts 13 protrudes upward from bottom wall 11. The pair of side wall parts 13 is provided at peripheral portions (left edge and right edge) of inner bottom wall 111. Side wall part 13 has a wall shape long in the front-rear direction.

Central wall part 14 protrudes upward from bottom wall 11. Central wall part 14 has an island wall shape long in the front-rear direction. Central wall part 14 is formed between the pair of side wall parts 13 on an upper surface of bottom wall 11. A pair of recesses 18 is formed along the front-rear direction between the pair of side wall parts 13 and central wall part 14. Note that the pair of side wall parts 13 may be (partially) connected to central wall part 14.

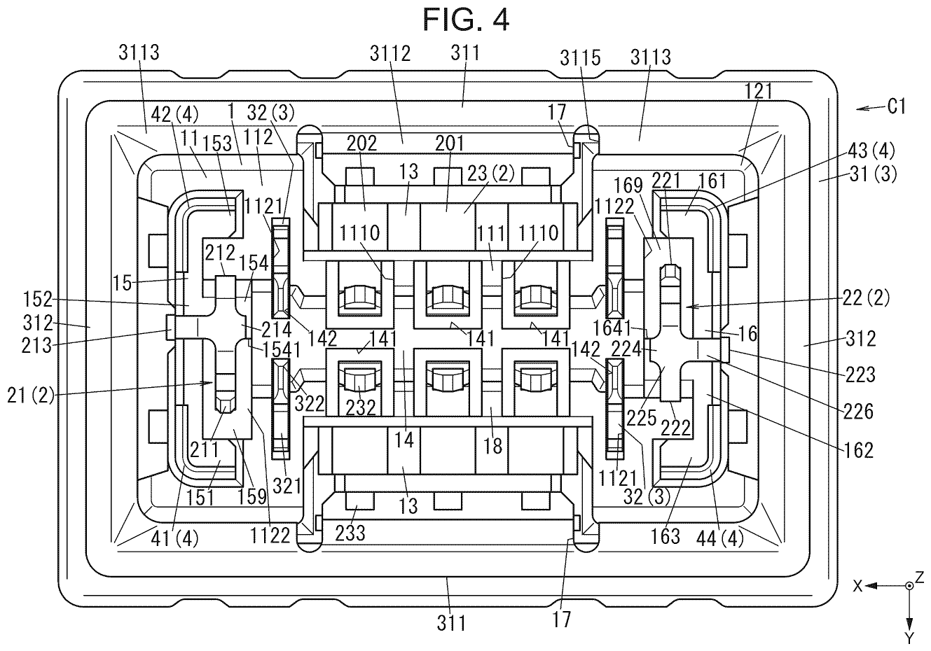

As illustrated in FIG. 4, a plurality of dents 141 (here, a total of six dents of three dents on a left side surface and three dents on a right side surface) are provided to be aligned in the front-rear direction on left and right side surfaces of central wall part 14. In inner bottom wall 111, a plurality of (here, six) through-holes 1110 penetrating vertically are formed to be connected to the plurality of dents 141 of central wall part 14.

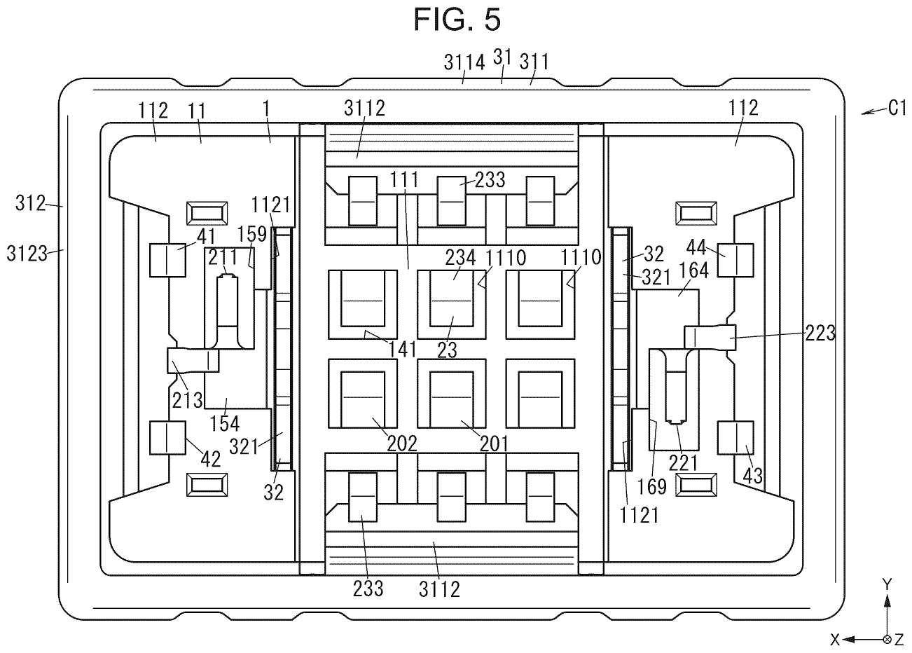

A pair of accommodation grooves 142 is formed on left and right side surfaces of a front end part and a rear end part of central wall part 14 (portions of central wall part 14 provided on outer bottom wall 112). As illustrated in FIGS. 4 and 5, an accommodation hole 1121 long in the left-right direction is formed in a lower surface of outer bottom wall 112 to be connected to the pair of left and right accommodation grooves 142 of central wall part 14.

As illustrated in FIGS. 3 and 4, first end wall part 15 protrudes upward from bottom wall 11. First end wall part 15 protrudes upward in an island shape from outer bottom wall 112 on the front side, of the pair of outer bottom walls 112. First end wall part 15 is provided at a front end of a central portion of outer bottom wall 112 on the front side in the left-right direction.

First end wall part 15 has an E shape as viewed from above. More specifically, first end wall part 15 includes first partition wall 151, second partition wall 152, third partition wall 153, and coupling wall 154. Second partition wall 152 has a wall shape extending in the left-right direction along the front end of outer bottom wall 112 on the front side. Coupling wall 154 connects a central portion of a rear surface of second partition wall 152 in the left-right direction and a front end of central wall part 14. First partition wall 151 has a wall shape extending rearward from a left end of second partition wall 152. Third partition wall 153 has a wall shape extending rearward from a right end of second partition wall 152. First partition wall 151 and second partition wall 152 are disposed in an L shape as viewed from above. Third partition wall 153 and second partition wall 152 are disposed in an L shape as viewed from above.

Dent 1541 is formed on a left side surface of coupling wall 154 to be recessed rightward. Through-hole 1122 vertically penetrating is formed in outer bottom wall 112 on the front side to be connected to dent 1541 of coupling wall 154. Space 159 having a rectangular shape as viewed from above is formed in housing 1 by dent 1541 of coupling wall 154 and through-hole 1122 of outer bottom wall 112. Note that coupling wall 154 may not be connected to central wall part 14. That is, first end wall part 15 may be separated from central wall part 14 with bottom wall 11 interposed therebetween.

As illustrated in FIGS. 3 and 4, second end wall part 16 protrudes upward from bottom wall 11. Second end wall part 16 protrudes upward from outer bottom wall 112 on the rear side, of the pair of outer bottom walls 112. Second end wall part 16 is provided at a rear end of a central portion in the left-right direction of outer bottom wall 112 on the rear side. Second end wall part 16 has a two-fold rotationally symmetric shape with first end wall part 15 around axis A1. Thus, a detailed description of second end wall part 16 is omitted. Note that second end wall part 16 includes first partition wall 161, second partition wall 162, third partition wall 163, and coupling wall 164 to correspond to first partition wall 151, second partition wall 152, third partition wall 153, and coupling wall 154 of first end wall part 15, respectively. Dent 1641 recessed leftward is provided on a right side surface of coupling wall 164 to be connected to through-hole 1122 formed in outer bottom wall 112 on the rear side. Space 169 having a rectangular shape as viewed from above is formed in housing 1 by dent 1641 of coupling wall 164 and through-hole 1122 of outer bottom wall 112.

### (1.2.2) Terminal

As illustrated in FIGS. 2 to 6, connector C1 includes a plurality of (here, eight) terminals 2. Terminal 2 is made of metal. The plurality of terminals 2 are held by housing 1. The plurality of terminals 2 are electrically connected to a plurality of mating terminals 6 included in mating connector C2 in a connected state where connector C1 and mating connector C2 are connected.

Here, the plurality of terminals 2 include first predetermined terminal 21, second predetermined terminal 22, and a plurality of (here, six) connection terminals 23. First predetermined terminal 21 and second predetermined terminal 22 are, for example, high frequency terminals for transmitting relatively high frequency signals to predetermined terminals 21 and 22. The plurality of connection terminals 23 are, for example, low frequency terminals for transmitting relatively low frequency signals. The plurality of connection terminals 23 may include a power supply terminal.

### (1.2.2.1) Predetermined Terminal

First predetermined terminal 21 is disposed on a foremost side in the front-rear direction, among the plurality of terminals 2. First predetermined terminal 21 is held by first end wall part 15 of housing 1.

As illustrated in FIG. 3, first predetermined terminal 21 integrally includes first contact part 211, second contact part 212, board connecting part 213, and coupling part 214.

First contact part 211 and second contact part 212 are portions of first predetermined terminal 21 that come into contact with first mating predetermined terminal 61 of mating connector C2 in the connected state where connector C1 and mating connector C2 are connected. First contact part 211 and second contact part 212 are disposed to be aligned in the left-right direction.

First contact part 211 has a plate shape whose thickness direction is along the left-right direction. A central portion of first contact part 211 is thicker than both ends (front end and rear end) in a width direction (front-rear direction). First contact part 211 is curved in a C shape to protrude leftward.

Second contact part 212 has a plate shape whose thickness direction is along the left-right direction. Second contact part 212 has a flat plate shape.

Board connecting part 213 is configured to be connected to circuit board B1. Board connecting part 213 has a plate shape whose thickness direction is along the upper-lower direction. Board connecting part 213 has a flat plate shape. Board connecting part 213 is fixed and electrically connected to a pad of circuit board B1 by, for example, soldering or the like.

Coupling part 214 couples the contact parts (first contact part 211 and second contact part 212) and board connecting part 213. Coupling part 214 couples first contact part 211, second contact part 212, and board connecting part 213. Note that the contact part may be at least one of first contact part 211 and second contact part 212.

Coupling part 214 includes first coupling part 215 that couples first contact part 211 and second contact part 212, and second coupling part 216 that couples first coupling part 215 and board connecting part 213. First coupling part 215 includes a flat part having a plate shape whose thickness direction is along the upper-lower direction, and a curved part which is coupled to a left end of the flat part and is curved in a U shape to protrude downward. Second coupling part 216 has an S-shaped (or Z-shaped) plate shape as viewed from a side.

As illustrated in FIGS. 2 to 4, first predetermined terminal 21 is held by first end wall part 15 of housing 1. As illustrated in FIG. 4, first contact part 211 is disposed in space 159. The curved part of first coupling part 215 is elastically deformed in the left-right direction, and thus, first contact part 211 is movable in the left-right direction in space 159. On the other hand, second contact part 212 is fixed to housing 1 (first end wall part 15).

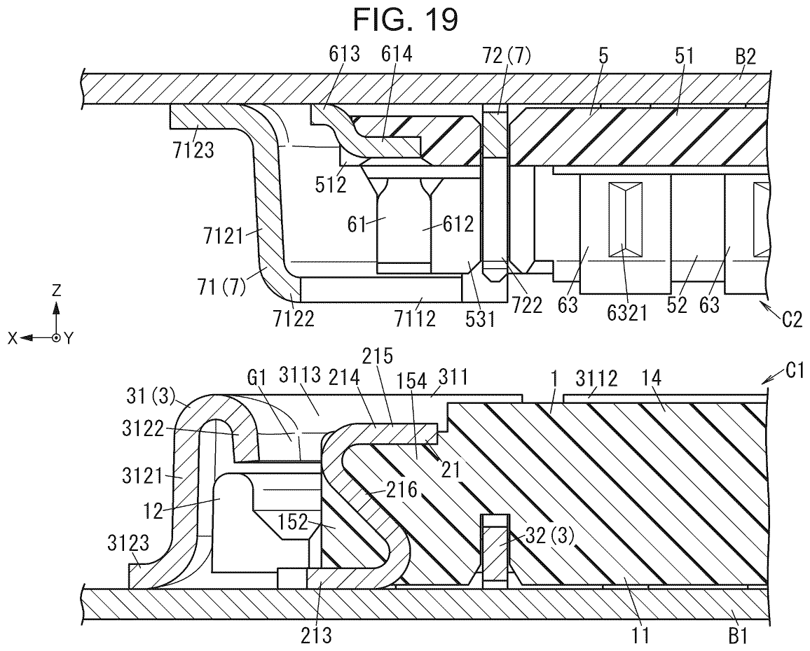

As illustrated in FIG. 5, a lower surface of board connecting part 213 is exposed from housing 1. As illustrated in FIG. 19, the lower surface of board connecting part 213 is at the same position as a lower surface of housing 1 or below the lower surface of housing 1 in the upper-lower direction (in the present exemplary embodiment, on a lower side). A front end of board connecting part 213 protrudes forward from the front end of outer bottom wall 112 on the front side of housing 1.

As illustrated in FIG. 4, second predetermined terminal 22 is disposed rearmost in the front-rear direction, among the plurality of terminals 2. Second predetermined terminal 22 is held by second end wall part 16 of housing 1.

Second predetermined terminal 22 has a shape obtained by rotating first predetermined terminal 21 by 180 degrees around axis A1 (see FIG. 2) set in housing 1. Thus, a detailed description of second predetermined terminal 22 is omitted. Note that, second predetermined terminal 22 includes first contact part 221, second contact part 222, board connecting part 223, and coupling part 224 (first coupling part 225 and second coupling part 226) to correspond to first contact part 211, second contact part 212, board connecting part 213, and coupling part 214 (first coupling part 215 and second coupling part 216) of first predetermined terminal 21, respectively (see FIG. 4).

### (1.2.2.2) Connection Terminal

As illustrated in FIGS. 2 to 5, the plurality of connection terminals 23 are disposed between first predetermined terminal 21 and second predetermined terminal 22 in the front-rear direction. The plurality of connection terminals 23 are held by the pair of side wall parts 13 of housing 1. Here, six connection terminals 23 are held to be aligned in the front-rear direction, three each on the pair of side wall parts 13.

As illustrated in FIG. 3, each connection terminal 23 integrally includes third contact part 231, fourth contact part 232, board connecting part 233, first coupling part 234, and second coupling part 235.

Third contact part 231 and fourth contact part 232 are portions of connection terminal 23 that come into contact with mating connection terminal 63 of mating connector C2 in the connected state where connector C1 and mating connector C2 are connected. Third contact part 231 and fourth contact part 232 are disposed to be aligned in the left-right direction.

Third contact part 231 has a plate shape whose thickness direction is along the left-right direction. Third contact part 231 has a flat plate shape.

Fourth contact part 232 has a plate shape whose thickness direction is along the left-right direction. Fourth contact part 232 is curved in a C shape to protrude toward third contact part 231. Fourth contact part 232 faces third contact part 231.

Board connecting part 233 is configured to be connected to circuit board B1. Board connecting part 233 has a plate shape whose thickness direction is along the upper-lower direction. Board connecting part 233 has a flat plate shape. Board connecting part 233 is fixed and electrically connected to the pad of circuit board B1 by, for example, soldering or the like.

First coupling part 234 couples third contact part 231 and fourth contact part 232. First coupling part 234 has a U-shaped plate shape coupling a lower end of third contact part 231 and a lower end of fourth contact part 232.

Second coupling part 235 couples third contact part 231 and board connecting part 233. Second coupling part 235 has a J-shaped plate shape coupling an upper end of third contact part 231 and board connecting part 233.

Connection terminal 23 is fixed to housing 1. Connection terminal 23 is held by housing 1 in a state where a part of first coupling part 234 (a portion coupled to third contact part 231) and a part of second coupling part 235 (a lower end part) are buried in side wall part 13.

Third contact part 231 is fixed to housing 1. On the other hand, fourth contact part 232 is disposed in recess 18 of housing 1 and is movable in the left-right direction in recess 18 (in particular, in a space including through-hole 1110).

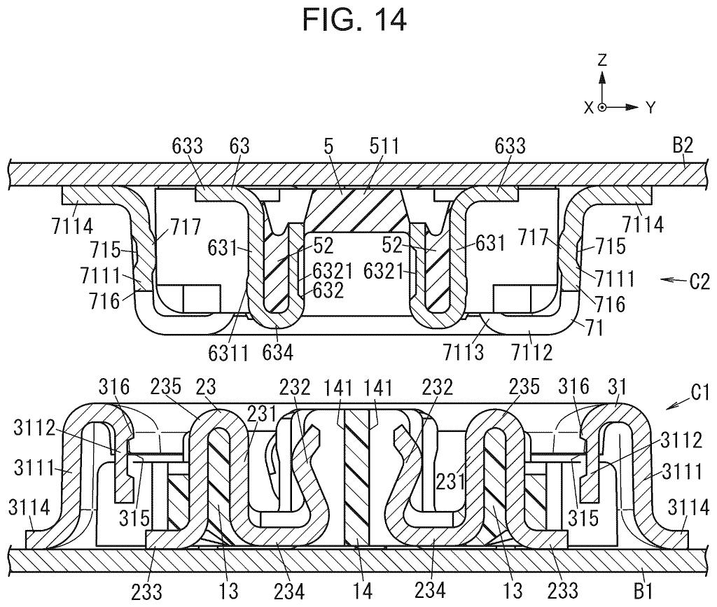

As illustrated in FIG. 5, a lower surface of board connecting part 233 is exposed from housing 1. As illustrated in FIG. 14, the lower surface of board connecting part 233 is at the same position as the lower surface of housing 1 or below the lower surface of housing 1 in the upper-lower direction (in the present exemplary embodiment, on a lower side). The lower surface of board connecting part 233 is at the same position as the lower surface of board connecting part 213 of first predetermined terminal 21 and the lower surface of the board connecting part 223 of second predetermined terminal 22 in the upper-lower direction. As illustrated in FIGS. 3 and 4, board connecting part 233 protrudes outward in the left-right direction from inner bottom wall 111 of housing 1.

As illustrated in FIGS. 4 and 5, the plurality of terminals 2 (the plurality of connection terminals 23) include first terminal 201. First terminal 201 may be any terminal 2 among the plurality of terminals 2. Here, first terminal 201 is connection terminal 23 disposed at a center in the front-rear direction, among three connection terminals 23 held by side wall part 13 on a right side.

The plurality of terminals 2 (the plurality of connection terminals 23) further include second terminal 202. Second terminal 202 is terminal 2 disposed at a position different from first terminal 201 in the front-rear direction, among the plurality of terminals 2. Second terminal 202 is aligned with first terminal 201 in the front-rear direction. Here, second terminal 202 is connection terminal 23 disposed on a foremost side, among three connection terminals 23 held by side wall part 13 on the right side.

### (1.2.3) Shield

As illustrated in FIGS. 2 to 6, shield 3 includes outer shield 31 and inner shield 32.

### (1.2.3.1) Outer Shield

Outer shield 31 contains metal as a main material or a material such as plating constituting a surface. Here, as an example, outer shield 31 is formed by using metal as a main material.

As illustrated in FIGS. 3 and 4, outer shield 31 integrally includes a pair of first outer shields 311 and a pair of second outer shields 312.

As illustrated in FIGS. 3 and 4, the pair of first outer shields 311 is formed to be long in the front-rear direction on a left side and a right side of housing 1. The pair of first outer shields 311 is disposed to face each other in the left-right direction. First predetermined terminal 21, second predetermined terminal 22, and the plurality of connection terminals 23 are disposed between the pair of first outer shields 311. First outer shield 311 faces first terminal 201 in the left-right direction. First outer shield 311 faces second terminal 202 in the left-right direction.

As illustrated in FIG. 3, first outer shield 311 includes outer wall 3111, first extension part 3112, a pair of second extension parts 3113, and flange 3114.

Outer wall 3111 has a wall shape facing entire housing 1 in the front-rear direction. Outer wall 3111 is disposed outward with respect to outer wall 12 of housing 1 in the left-right direction.

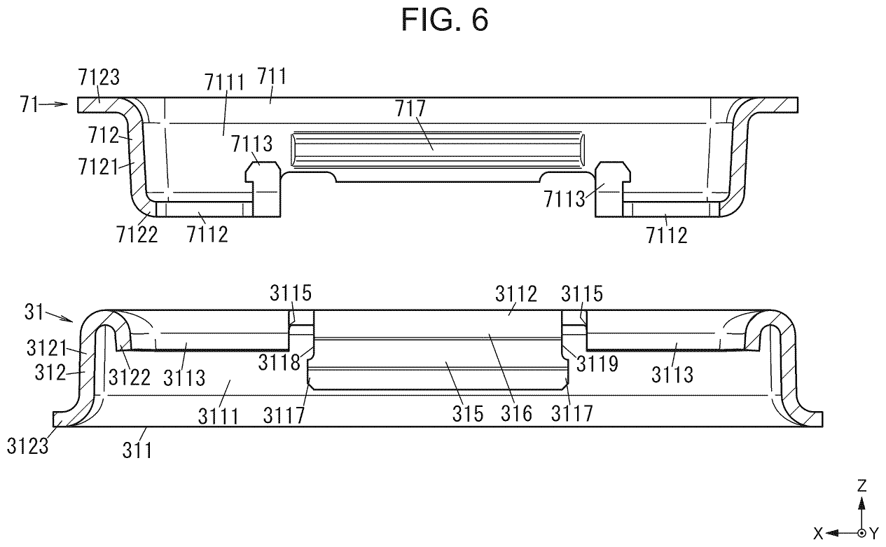

As illustrated in FIGS. 3 and 6, first extension part 3112 is curved inward of connector C1 from an upper end of outer wall 3111. First extension part 3112 is curved inward and extends downward from an upper end of a central portion of outer wall 3111 in the front-rear direction. First extension part 3112 is formed to face side wall part 13 over the entire length of side wall part 13 of housing 1 in the front-rear direction. First extension part 3112 has front end 3118 and rear end 3119 at both ends in the front-rear direction. First extension part 3112 faces side wall part 13 of housing 1 in the left-right direction. First extension part 3112 faces first terminal 201 and second terminal 202 in the left-right direction.

As illustrated in FIGS. 3 and 6, recess 315 is formed on an inner surface of first extension part 3112. Recess 315 is formed to be recessed outward in the left-right direction. Recess 315 has a groove shape long in the front-rear direction. Recess 315 is formed to extend in the front-rear direction to face first terminal 201 and second terminal 202 in the left-right direction. Recess 315 is formed from front end 3118 to rear end 3119 of first extension part 3112 (over entire first extension part 3112 in the front-rear direction). As illustrated in FIG. 14, a surface of first extension part 3112 on a back side of recess 315 is planar.

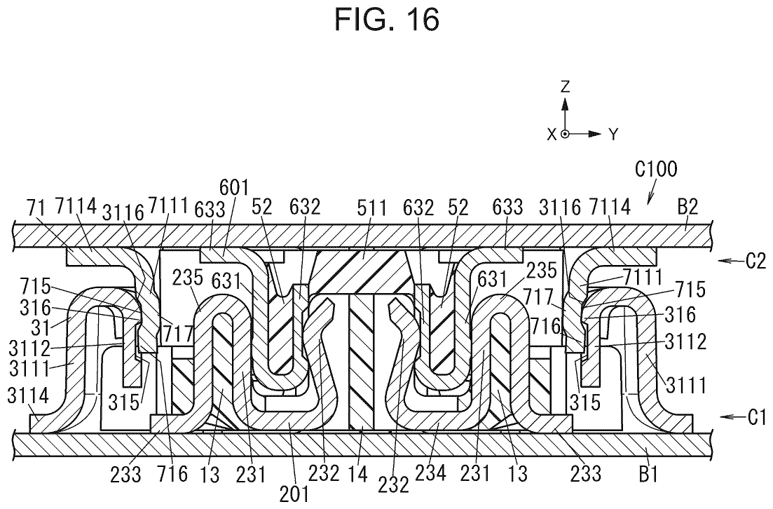

Insertion part 316 protruding inward in the left-right direction from recess 315 is formed above recess 315 in first extension part 3112. Insertion part 316 is disposed in mating recess 715 of first mating outer shield 711 to be described later in the connected state where connector C1 and mating connector C2 are connected (see FIG. 16). Insertion part 316 is formed from front end 3118 to rear end 3119 of first extension part 3112. As illustrated in FIG. 16, insertion part 316 includes curved surface 3116 of first extension part 3112 of first outer shield 311.

As described above, first outer shield 311 includes recess 315 recessed outward of connector C1 in the left-right direction, and insertion part 316 formed above recess 315 and continuous with an upper surface of recess 315. Recess 315 and insertion part 316 are formed in first extension part 3112 of first outer shield 311.

First extension part 3112 has protrusions protruding in the front-rear direction at front end 3118 and rear end 3119. Both ends of first extension parts 3112 of the pair of first outer shields 311 in the front-rear direction are press-fitted into the pair of notches 17 (see FIG. 3) of housing 1, and thus, outer shield 31 is held by housing 1. As described above, front end 3118 and rear end 3119 of first extension part 3112 of first outer shield 311 have holding part 3117 (protrusion) held by housing 1. As illustrated in FIGS. 3 and 6, recess 315 is also formed in holding part 3117. Both ends of first extension parts 3112 of the pair of first outer shields 311 in the front-rear direction are press-fitted into a pair of recesses (not illustrated) of housing 1, and thus, outer shield 31 is held by housing 1.

As illustrated in FIGS. 3 and 6, second extension part 3113 is curved inward of connector C1 from the upper end of outer wall 3111. The pair of second extension parts 3113 is curved inward and extends downward from upper ends of a front portion and a rear portion of outer wall 3111.

Second extension part 3113 is aligned with first extension part 3112 in the front-rear direction. In the front-rear direction, first extension part 3112 is disposed between the pair of second extension parts 3113. However, first extension part 3112 and second extension part 3113 are not connected in the front-rear direction, and slit (gap) 3115 is formed between first extension part 3112 and second extension part 3113.

Here, as illustrated in FIGS. 2 to 4 and 6, slit 3115 is not formed in outer wall 3111. That is, slit 3115 is formed only in a portion of first outer shield 311 inside an upper end of first outer shield 311. Thus, as illustrated in FIG. 6, the upper end of outer wall 3111 (the upper end of first outer shield 311) has a linear shape without a step as viewed from the side. It can be said that front end 3118 and rear end 3119 of first extension part 3112 are formed from an uppermost end of a coupling part between outer wall 3111 and first extension part 3112.

As illustrated in FIG. 12, a lowermost end of second extension part 3113 is above an uppermost end of outer wall 12 of housing 1. The lowermost end of second extension part 3113 overlaps the uppermost end of outer wall 12 of housing 1 in the upper-lower direction via gap G10.

Flange 3114 extends outward from a lower end of outer wall 3111. Flange 3114 is a portion connected to circuit board B1 in outer shield 31. Flange 3114 is fixed to and electrically connected to a ground pattern of circuit board B1 by, for example, soldering or the like.

As illustrated in FIGS. 3 and 4, the pair of second outer shields 312 is formed long in the left-right direction on the front side and the rear side of housing 1. The pair of second outer shields 312 is disposed to face each other in the front-rear direction.

Of the pair of second outer shields 312, second outer shield 312 on a front side is disposed in front of first predetermined terminal 21 and faces first end wall part 15 and first predetermined terminal 21. Of the pair of second outer shields 312, second outer shield 312 on a rear side is disposed behind second predetermined terminal 22 and faces second end wall part 16 and second predetermined terminal 22.

Second outer shield 312 includes outer wall 3121, extension part 3122, and flange 3123.

Outer wall 3121 has a wall shape facing entire housing 1 in the left-right direction. Outer wall 3121 is disposed outward with respect to outer wall 12 of housing 1 in the front-rear direction.

Extension part 3122 is curved inward and extends downward from an upper end of outer wall 3121.

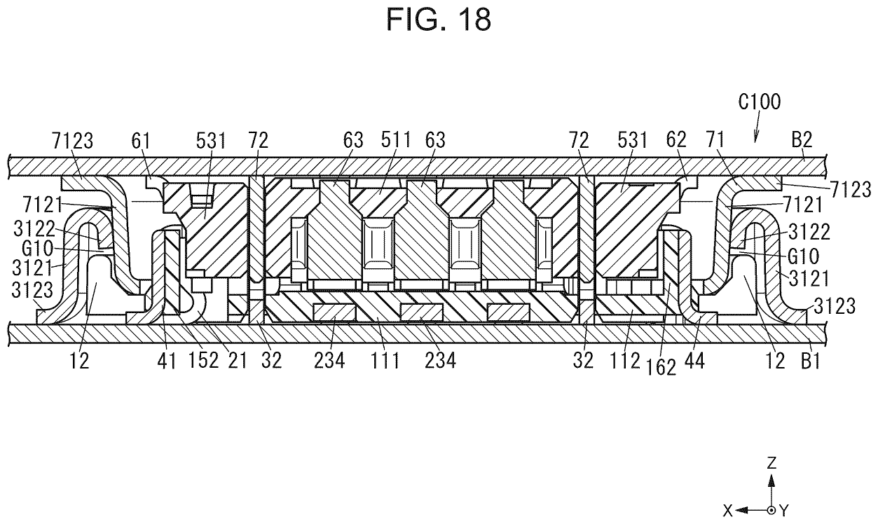

As illustrated in FIG. 18, a lowermost end of extension part 3122 is above the uppermost end of outer wall 12 of housing 1. Lowermost ends of left and right end parts of extension part 3122 overlap the uppermost end of outer wall 12 of housing 1 in the upper-lower direction via gap G10.

Flange 3123 extends outward from a lower end of outer wall 3121. Flange 3123 is a portion of outer shield 31 connected to circuit board B1. Flange 3123 is fixed to and electrically connected to a ground pattern of circuit board B1 by, for example, soldering or the like.

As illustrated in FIGS. 3 and 4, an end of first outer shield 311 and an end of second outer shield 312 are connected to each other, and thus, outer shield 31 is formed in a rectangular frame shape surrounding a hollow space as viewed from above. The plurality of terminals 2 are disposed inside outer shield 31 having a rectangular frame shape. That is, outer shield 31 surrounds the plurality of terminals 2 and surrounds first terminal 201 and second terminal 202. As a result, electromagnetic shielding properties are improved.

An outer surface of outer shield 31 is seamless over an entire circumference in a circumferential direction. “Seamless” means that there is no joint or break.

### (1.2.3.2) Inner Shield

Shield 3 includes two inner shields 32. Inner shield 32 contains metal as a main material or a material such as plating constituting a surface. Here, as an example, inner shield 32 is formed by using metal as a main material.

In the present exemplary embodiment, shapes of two inner shields 32 are the same. Inner shield 32 has a plate shape whose thickness direction is along the front-rear direction. As illustrated in FIG. 3, inner shield 32 integrally includes base 321 and a plurality of (a pair of) protrusions 322.

Base 321 has a plate shape long in the left-right direction.

Protrusion 322 protrudes upward from base 321. The pair of protrusions 322 is provided at symmetrical positions in the left-right direction at an upper end of base 321.

As illustrated in FIGS. 4 and 5, in inner shield 32, base 321 is accommodated in accommodation hole 1121 of outer bottom wall 112 of housing 1, and the pair of protrusions 322 is press-fitted into the pair of accommodation grooves 142 of central wall part 14 and is held by housing 1.

As illustrated in FIG. 4, first predetermined terminal 21 is surrounded by outer shield 31 (the pair of first outer shields 311 and second outer shield 312 on the front side) and inner shield 32 on a front side. Second predetermined terminal 22 is surrounded by outer shield 31 (the pair of first outer shields 311 and second outer shield 312 on the rear side) and inner shield 32 on the rear side. The plurality of connection terminals 23 are surrounded by outer shield 31 (the pair of first outer shields 311) and two inner shields 32.

Inner shield 32 is connected to circuit board B1. Base 321 of inner shield 32 is fixed to and electrically connected to a ground pattern of circuit board B1 by, for example, soldering or the like. As a result, outer shield 31 and inner shield 32 have the same potential.

### (1.2.4) Guard

Guard 4 is a member for preventing, for example, mating outer shield 71 of mating connector C2 from coming into contact with first predetermined terminal 21 (or second predetermined terminal 22) and damaging first predetermined terminal 21 (or second predetermined terminal 22) when connector C1 and mating connector C2 are connected.

As illustrated in FIGS. 3 to 5, guard 4 includes first guard member 41, second guard member 42, third guard member 43, and fourth guard member 44 which are separated from each other.

First guard member 41 to fourth guard member 44 contain metal as a main material or a material such as plating constituting a surface. Here, as an example, first guard member 41 to fourth guard member 44 are mainly made of metal. That is, guard 4 (first guard member 41 to fourth guard member 44) is made of metal. Guard 4 is formed by punching or bending a metal plate.

Guard 4 (first guard member 41 to fourth guard member 44) is electrically insulated from shield 3 (outer shield 31 and inner shield 32) and the plurality of terminals 2. That is, first guard member 41 to fourth guard member 44 do neither come into contact with shield 3 nor the plurality of terminals 2, and are not electrically connected.

Guard 4 is held by housing 1. First guard member 41 and second guard member 42 are held by first end wall part 15 of housing 1. Third guard member 43 and fourth guard member 44 are held by second end wall part 16 of housing 1.

As illustrated in FIG. 4, first guard member 41 is disposed at a portion on a left front side of first end wall part 15, and covers a coupling part (including a corner part) of first end wall part 15 between first partition wall 151 and second partition wall 152.

Second guard member 42 is disposed in a portion on a right front side of first end wall part 15, and covers a joint portion (including a corner part) of first end wall part 15 between second partition wall 152 and third partition wall 153. Second guard member 42 is disposed to be separated from first guard member 41 in the left-right direction. In the left-right direction, first contact part 211 and second contact part 212 are disposed between first guard member 41 and second guard member 42.

Third guard member 43 is disposed in a portion on a right rear side of second end wall part 16, and covers a joint portion (including a corner part) of second end wall part 16 between first partition wall 161 and second partition wall 162.

Fourth guard member 44 is disposed in a portion on a left rear side of second end wall part 16, and covers a joint portion (including a corner part) of second end wall part 16 between first partition wall 161 and third partition wall 163.

Guard 4 (first guard member 41 to fourth guard member 44) is fixed to circuit board B1 by, for example, soldering or the like.

### (1.3) Mating Connector

As illustrated in FIGS. 7 to 10, mating connector C2 includes mating housing 5, a plurality of mating terminals 6, and mating shield 7.

### (1.3.1) Mating Housing

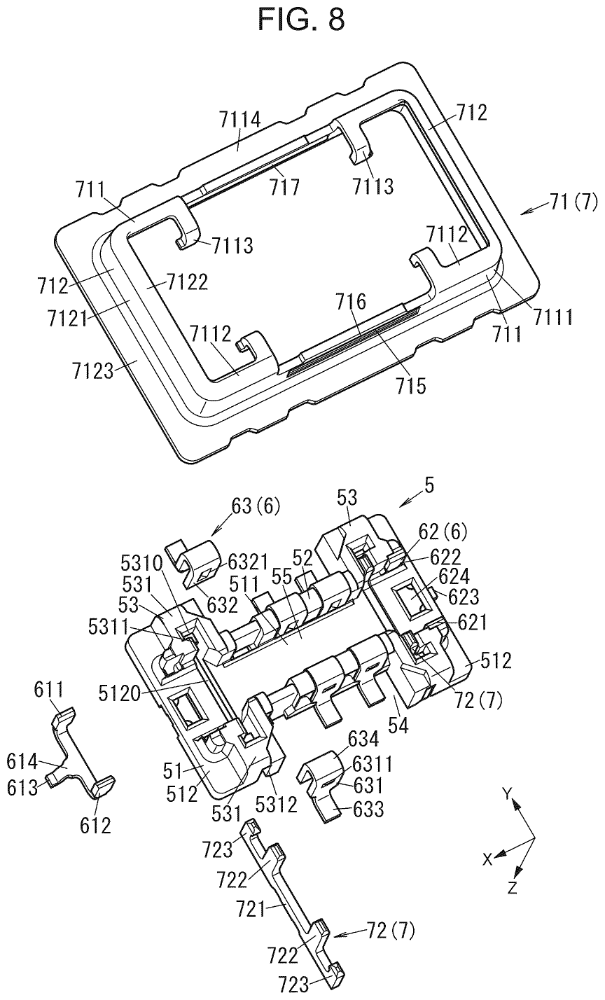

Mating housing 5 is made of an insulating resin material and is formed in a substantially rectangular parallelepiped shape long in the front-rear direction as illustrated in FIG. 8. Mating housing 5 has a two-fold rotationally symmetric shape around axis A2 (see FIG. 7) that passes through a center of mating housing 5 and is along the upper-lower direction. Mating housing 5 holds the plurality of mating terminals 6 and mating shield 7.

As illustrated in FIG. 8, mating housing 5 integrally includes mating bottom wall 51, a pair of mating side wall parts 52, and a pair of mating holding wall parts 53.

Mating bottom wall 51 has a plate shape whose thickness direction is along the upper-lower direction. Mating bottom wall 51 integrally includes mating inner bottom wall 511 and a pair of mating outer bottom walls 512.

Mating inner bottom wall 511 has a rectangular plate shape as viewed from below.

The pair of mating outer bottom walls 512 is connected to both front and rear ends of mating inner bottom wall 511, respectively. Each of the pair of mating outer bottom walls 512 has a rectangular shape as viewed from below, and has a plate shape whose dimension in the left-right direction is larger than a dimension of mating inner bottom wall 511.

On left and right side surfaces of mating bottom wall 51, there is a step at a joint portion between mating inner bottom wall 511 and mating outer bottom wall 512. As a result, mating housing 5 has mating dent 54 at a center in the front-rear direction on both left and right side surfaces, and is formed in an H shape in bottom view.

The pair of mating side wall parts 52 protrudes downward from mating bottom wall 51. The pair of mating side wall parts 52 is provided at peripheral portions (left edge and right edge) of mating inner bottom wall 511. Mating side wall part 52 has a wall shape long in the front-rear direction. Mating recess 55 is formed to be surrounded by mating inner bottom wall 511 and the pair of mating side wall parts 52.

The pair of mating holding wall parts 53 protrudes downward from mating bottom wall 51. One of the pair of mating holding wall parts 53 is provided on mating outer bottom wall 512 on the front side. The other of the pair of mating holding wall parts 53 is provided on mating outer bottom wall 512 on the rear side.

Each of the pair of mating holding wall parts 53 has two mating partial wall parts 531. Two mating partial wall parts 531 face each other with a gap therebetween in the left-right direction. Each of two mating partial wall parts 531 is connected to the pair of mating side wall parts 52 in the front-rear direction.

At a center of a lower surface of mating partial wall part 531, holding dent 5310 is formed to be recessed upward.

In each of two mating partial wall parts 531, first mating accommodation groove 5311 is formed on facing surfaces in the left-right direction. Mating accommodation hole 5120 long in the left-right direction is formed in mating outer bottom wall 512 to connect first mating accommodation grooves 5311 of two mating partial wall parts 531. In each of two mating partial wall parts 531, second mating accommodation groove 5312 is formed on an outer side surface in the left-right direction.

### (1.3.2) Mating Terminal

As illustrated in FIGS. 7 to 10, mating connector C2 includes a plurality of (here, eight) mating terminals 6. Mating terminal 6 is made of metal. The plurality of mating terminals 6 are held by mating housing 5. The plurality of mating terminals 6 are electrically connected to the plurality of terminals 2 included in connector C1 in the connected state where connector C1 and mating connector C2 are connected.

Here, the plurality of mating terminals 6 include first mating predetermined terminal 61, second mating predetermined terminal 62, and a plurality of (here, six) mating connection terminals 63. First mating predetermined terminal 61 and second mating predetermined terminal 62 are, for example, high frequency terminals for transmitting relatively high frequency signals. The plurality of mating connection terminals 63 are, for example, low frequency terminals for transmitting relatively low frequency signals.

(1.3.2.1) Mating predetermined terminal

First mating predetermined terminal 61 is disposed on a foremost side in the front-rear direction, among the plurality of mating terminals 6. First mating predetermined terminal 61 is connected to first predetermined terminal 21 of connector C1.

As illustrated in FIG. 8, first mating predetermined terminal 61 integrally includes first mating contact part 611, second mating contact part 612, mating board connecting part 613, and mating coupling part 614.

First mating contact part 611 and second mating contact part 612 are portions of first mating predetermined terminal 61 that come into contact with first predetermined terminal 21 of connector C1 in the connected state where connector C1 and mating connector C2 are connected. First mating contact part 611 and second mating contact part 612 are disposed to be aligned in the left-right direction. First mating contact part 611 is positioned on a left side, and second mating contact part 612 is positioned on a right side.

First mating contact part 611 has a plate shape whose thickness direction is along the left-right direction. First mating contact part 611 has a flat plate shape.

Second mating contact part 612 has a plate shape whose thickness direction is along the left-right direction. Second mating contact part 612 has a flat plate shape.

Mating board connecting part 613 is configured to be connected to mating circuit board B2. Mating board connecting part 613 has a plate shape whose thickness direction is along the upper-lower direction. Mating board connecting part 613 has a flat plate shape. Mating board connecting part 613 is fixed to and electrically connected to pads of mating circuit board B2 by, for example, soldering or the like.

Mating coupling part 614 couples first mating contact part 611, second mating contact part 612, and mating board connecting part 613. Mating coupling part 614 has a T-shaped plate shape as viewed from below. Mating coupling part 614 couples first mating contact part 611, second mating contact part 612, and mating board connecting part 613 such that mating board connecting part 613 is positioned above first mating contact part 611 and second mating contact part 612.

As illustrated in FIGS. 7 to 10, first mating predetermined terminal 61 is buried in mating outer bottom wall 512 and mating holding wall part 53 on the front side of mating housing 5 and is held by mating housing 5.

First mating contact part 611 is fixed to mating housing 5. Second mating contact part 612 is fixed to mating housing 5.

Mating coupling part 614 is buried in mating outer bottom wall 512 on the front side. A dent is formed at a center of a lower surface of mating outer bottom wall 512, and a central portion in the left-right direction on a lower surface of mating coupling part 614 is exposed via the dent.

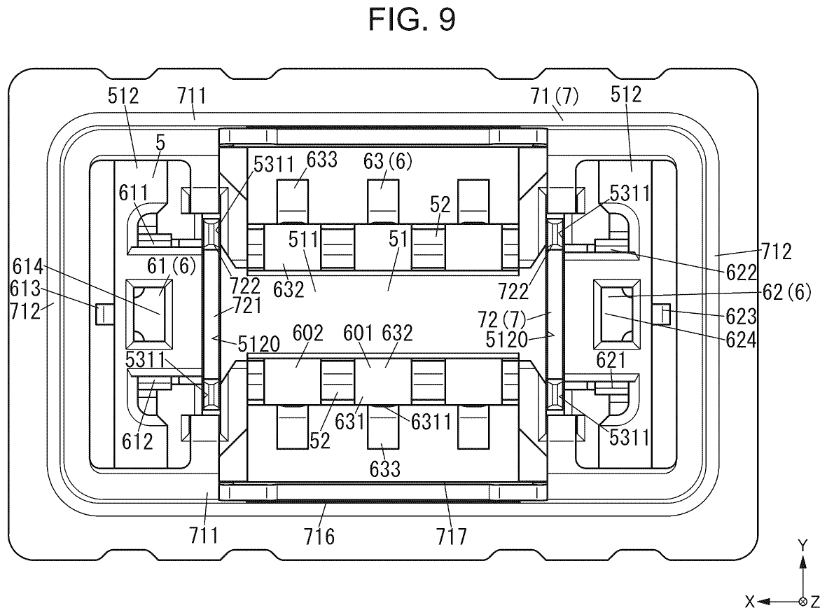

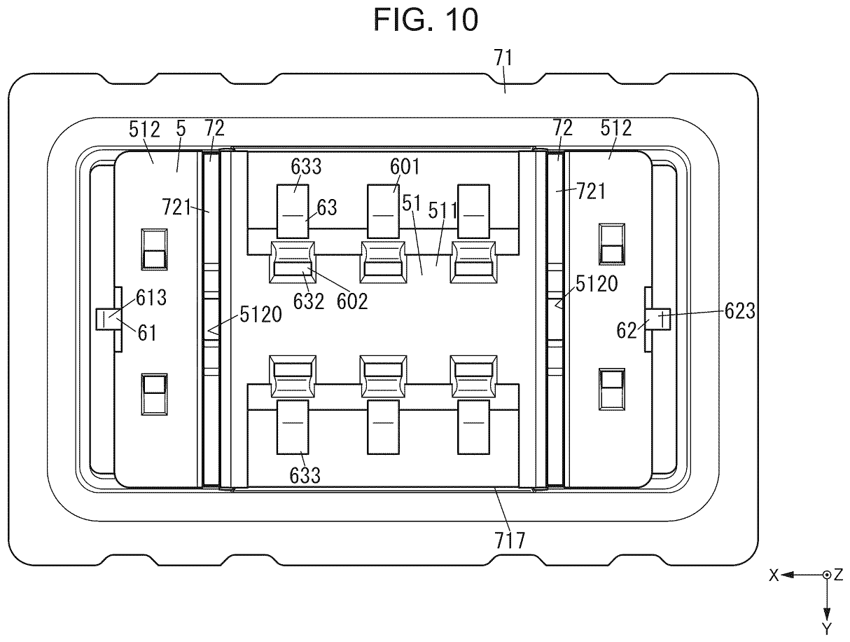

As illustrated in FIGS. 9 and 10, mating board connecting part 613 protrudes forward from a front end of mating housing 5. An upper surface of mating board connecting part 613 is exposed from mating housing 5. As illustrated in FIG. 19, the upper surface of mating board connecting part 613 is at the same position as the upper surface of mating housing 5 or above the upper surface of mating housing 5 in the upper-lower direction (in the present exemplary embodiment, on the upper side).

As illustrated in FIG. 7, second mating predetermined terminal 62 is disposed rearmost in the front-rear direction, among the plurality of mating terminals 6. Second mating predetermined terminal 62 is connected to second predetermined terminal 22 of connector C1.

Second mating predetermined terminal 62 has a shape obtained by rotating first mating predetermined terminal 61 by 180 degrees around axis A2 (see FIG. 7) set in mating housing 5. Thus, a detailed description of second mating predetermined terminal 62 is omitted. Note that, second mating predetermined terminal 62 includes first mating contact part 621, second mating contact part 622, mating board connecting part 623, and mating coupling part 624 to correspond to first mating contact part 611, second mating contact part 612, mating board connecting part 613, and mating coupling part 614 of first mating predetermined terminal 61, respectively.

### (1.3.2.2) Mating Connection Terminal

As illustrated in FIGS. 7 to 10, the plurality of mating connection terminals 63 are disposed between first mating predetermined terminal 61 and second mating predetermined terminal 62 in the front-rear direction. The plurality of mating connection terminals 63 are connected to the plurality of connection terminals 23 of connector C1, respectively.

The plurality of mating connection terminals 63 are held by the pair of mating side wall parts 52 of mating housing 5. Here, six mating connection terminals 63 are held to be aligned in the front-rear direction, three for each of the pair of mating side wall parts 52.

As illustrated in FIG. 8, mating connection terminal 63 integrally includes third mating contact part 631, fourth mating contact part 632, mating board connecting part 633, and mating coupling part 634.

Third mating contact part 631 and fourth mating contact part 632 are portions of mating connection terminal 63 that come into contact with connection terminal 23 of connector C1 in the connected state where connector C1 and mating connector C2 are connected. Third mating contact part 631 and fourth mating contact part 632 are disposed to be aligned in the left-right direction.

Third mating contact part 631 has a plate shape whose thickness direction is along the left-right direction. Third mating contact part 631 has a flat plate shape. Third mating contact part 631 has projection 6311 on a surface opposite to a facing surface facing fourth mating contact part 632.

Fourth mating contact part 632 has a plate shape whose thickness direction is along the left-right direction. Fourth mating contact part 632 has a flat plate shape. Fourth mating contact part 632 is disposed inside third mating contact part 631 in the left-right direction. Fourth mating contact part 632 has recess 6321 on the surface opposite to the facing surface facing third mating contact part 631.

Mating board connecting part 633 is configured to be connected to mating circuit board B2. Mating board connecting part 633 has a plate shape whose thickness direction is along the upper-lower direction. Mating board connecting part 633 has a flat plate shape. Mating board connecting part 633 is fixed to and electrically connected to pads of mating circuit board B2 by, for example, soldering or the like.

Mating coupling part 634 couples third mating contact part 631 and fourth mating contact part 632. Mating coupling part 634 has a U-shaped plate shape that couples a lower end of third mating contact part 631 and a lower end of fourth mating contact part 632.

Mating connection terminal 63 is fixed to mating housing 5. Mating connection terminal 63 is held by mating housing 5 to straddle left and right side surfaces of mating side wall part 52 of mating housing 5.

Third mating contact part 631 is fixed to mating housing 5. Fourth mating contact part 632 is fixed to mating housing 5.

As illustrated in FIG. 10, an upper surface of mating board connecting part 633 is exposed from mating housing 5. As illustrated in FIG. 14, the upper surface of mating board connecting part 633 is at the same position as the upper surface of mating housing 5 or above the upper surface of mating housing 5 in the upper-lower direction (in the present exemplary embodiment, on the upper side). The upper surface of mating board connecting part 633 is at the same position as the upper surface of mating board connecting part 613 of first mating predetermined terminal 61 and the upper surface of the mating board connecting part 623 of second mating predetermined terminal 62 in the upper-lower direction. As illustrated in FIGS. 9 and 10, mating board connecting part 633 protrudes outward in the left-right direction from mating inner bottom wall 511 of mating housing 5.

As illustrated in FIGS. 7, 9, and 10, the plurality of mating terminals 6 (the plurality of mating connection terminals 63) include first mating terminal 601. First mating terminal 601 is mating terminal 6 connected to first terminal 201 of connector C1, among the plurality of mating terminals 6. Here, first mating terminal 601 is mating connection terminal 63 disposed at a center in the front-rear direction, among three mating connection terminals 63 held by mating side wall part 52 on a right side.

The plurality of mating terminals 6 (the plurality of mating connection terminals 63) further include second mating terminal 602. Second mating terminal 602 is mating terminal 6 connected to second terminal 202 of connector C1, among the plurality of mating terminals 6. Second mating terminal 602 is aligned with first mating terminal 601 in the front-rear direction. Here, second mating terminal 602 is mating connection terminal 63 disposed at a foremost position, among three mating connection terminals 63 held by mating side wall part 52 on the right side.

### (1.3.3) Mating Shield

As illustrated in FIGS. 7 to 10, mating shield 7 includes mating outer shield 71 and mating inner shield 72. Mating shield 7 is electrically connected to shield 3 included in connector C1 in the connected state where connector C1 and the mating connector C2 are connected.

### (1.3.3.1) Mating Outer Shield

Mating outer shield 71 contains metal as a main material or a material such as plating constituting a surface. Here, as an example, mating outer shield 71 is formed by using metal as a main material.

Mating outer shield 71 is connected to outer shield 31 of connector C1 in the connected state where connector C1 and mating connector C2 are connected.

As illustrated in FIGS. 8 and 9, mating outer shield 71 integrally includes a pair of first mating outer shields 711 and a pair of second mating outer shields 712.

As illustrated in FIGS. 8 and 9, the pair of first mating outer shields 711 is formed to be long in the front-rear direction on a left side and a right side of mating housing 5. The pair of first mating outer shields 711 faces each other in the left-right direction. First mating predetermined terminal 61, second mating predetermined terminal 62, and the plurality of mating connection terminals 63 are disposed between the pair of first mating outer shields 711. First mating outer shield 711 faces first mating terminal 601 in the left-right direction. First mating outer shield 711 faces second mating terminal 602 in the left-right direction.

As illustrated in FIG. 8, first mating outer shield 711 includes mating outer wall 7111, a pair of mating extension parts 7112, a pair of additional extension parts 7113, and mating flange 7114.

Mating outer wall 7111 has a wall shape facing entire mating housing 5 in the front-rear direction. Mating outer wall 7111 is disposed outward with respect to mating housing 5 in the left-right direction.

As illustrated in FIG. 8, mating recess 715 is formed on an outer surface of mating outer wall 7111 in the left-right direction. Mating recess 715 is formed to be recessed inward in the left-right direction. Mating recess 715 has a groove shape elongated in the front-rear direction. A length of mating recess 715 in the front-rear direction is longer than a length of insertion part 316 of first outer shield 311 of connector C1 in the front-rear direction.

As illustrated in FIGS. 6 to 8, mating projection 717 is formed on a back side of mating recess 715 (inner surface of mating outer wall 7111 in the left-right direction) in mating outer wall 7111. Mating projection 717 is formed to protrude inward in the left-right direction. Mating projection 717 is formed to be long in the front-rear direction. For example, mating projection 717 is formed simultaneously when mating recess 715 is formed by pressing mating outer wall 7111 inward in the left-right direction. As described above, first mating outer shield 711 has mating projection 717 protruding inward of mating connector C2 on the back side of mating recess 715. Mating projection 717 is disposed, and thus, a thickness (dimension in the left-right direction) of a portion of mating outer wall 7111 where mating recess 715 is provided can be increased. For example, a thickness of a portion of mating outer wall 7111 where mating recess 715 is provided and a thickness of a portion where mating recess 715 is not provided can be made substantially the same. As a result, the strength of mating outer wall 7111 can be secured.

On mating outer wall 7111, mating insertion part 716 protruding outward in the left-right direction from mating recess 715 is formed below mating recess 715. Mating insertion part 716 is disposed in recess 315 of first outer shield 311 in the connected state where connector C1 and mating connector C2 are connected (see FIG. 16).

As described above, first mating outer shield 711 includes mating recess 715 recessed inward of mating connector C2 in the left-right direction and mating insertion part 716 formed below mating recess 715. Mating recess 715 and mating insertion part 716 are formed in mating outer wall 7111 of first mating outer shield 711.

The pair of mating extension parts 7112 is disposed on both sides of mating outer wall 7111 in the front-rear direction. The pair of mating extension parts 7112 has a shape curved inward in an L shape from lower ends of a front side portion and a rear side portion of mating outer wall 7111. A space between the pair of mating extension parts 7112 in the front-rear direction is a portion (central portion in the front-rear direction) corresponding to mating inner bottom wall 511 of mating housing 5. Mating extension part 7112 is not formed and there is a gap between the pair of mating extension parts 7112 in the front-rear direction. A length of mating recess 715 is shorter than an interval between the pair of mating extension parts 7112. Mating recess 715 is formed in a portion of mating outer wall 7111 where the pair of mating extension parts 7112 is not provided in the front-rear direction.

The pair of additional extension parts 7113 is curved inward in an L shape and extends upward from an inner end in the front-rear direction of each of the pair of mating extension parts 7112. Additional extension part 7113 is inserted into holding dent 5310 formed in the lower surface of mating partial wall part 531 of mating holding wall part 53 of mating housing 5. A total of four additional extension parts 7113 included in mating outer shield 71 are press-fitted into a total of four holding dents 5310 included in mating housing 5, and thus, mating outer shield 71 is held by mating housing 5. Mating outer shield 71 includes additional extension parts 7113, and thus, positioning can be easily performed when mating outer shield 71 is attached to mating housing 5.

Mating flange 7114 extends outward from an upper end of mating outer wall 7111. Mating flange 7114 is a portion of mating outer shield 71 connected to mating circuit board B2. Mating flange 7114 is fixed to and electrically connected to a ground pattern of mating circuit board B2 by, for example, soldering or the like.

As illustrated in FIGS. 8 and 9, the pair of second mating outer shields 712 is formed to be long in the left-right direction on a front side and a rear side of mating housing 5. The pair of second mating outer shields 712 is disposed to face each other in the front-rear direction. Of the pair of second mating outer shields 712, second mating outer shield 712 on a front side is disposed in front of first mating predetermined terminal 61. Second mating outer shield 712 on the front side is coupled to front ends of the pair of first mating outer shields 711. Of the pair of second mating outer shields 712, second mating outer shield 712 on a rear side is disposed behind second mating predetermined terminal 62. Second mating outer shield 712 on the rear side is coupled to rear ends of the pair of first mating outer shields 711.

As illustrated in FIG. 8, second mating outer shield 712 includes mating outer wall 7121, mating extension part 7122, and mating flange 7123.

Mating outer wall 7121 has a wall shape facing entire mating housing 5 in the left-right direction. Mating outer wall 7121 is disposed outward with respect to mating housing 5 in the front-rear direction.

Mating extension part 7122 is curved inward from a lower end of mating outer wall 7121.

Mating flange 7123 extends outward from an upper end of mating outer wall 7121. Mating flange 7123 is a portion connected to mating circuit board B2 in mating outer shield 71. Mating flange 7123 is fixed to and electrically connected to the ground pattern of mating circuit board B2 by, for example, soldering or the like.

As illustrated in FIGS. 9 and 10, entire second mating outer shield 712 does not overlap mating housing 5 in the upper-lower direction. Second mating outer shield 712 on the front side faces a foremost end of mating housing 5 via a space as viewed from the upper-lower direction. Second mating outer shield 712 on the rear side faces a rearmost end of mating housing 5 via a space as viewed from the upper-lower direction.

As illustrated in FIGS. 8 and 9, an end of first mating outer shield 711 and an end of second mating outer shield 712 are connected to each other, and thus, mating outer shield 71 is formed in a rectangular frame shape surrounding a hollow space as viewed from below. The plurality of mating terminals 6 are disposed inside mating outer shield 71 having a rectangular frame shape. That is, mating outer shield 71 surrounds the plurality of mating terminals 6 and surrounds first mating terminal 601 and second mating terminal 602. As a result, electromagnetic shielding properties are improved.

An outer surface of mating outer shield 71 is seamless over an entire circumference in a circumferential direction.

### (1.3.3.2) Mating Inner Shield

Mating shield 7 includes two mating inner shields 72. Mating inner shield 72 contains metal as a main material or a material such as plating constituting a surface. Here, as an example, mating inner shield 72 is formed by using metal as a main material.

In the present exemplary embodiment, shapes of two mating inner shields 72 are the same. Mating inner shield 72 has a plate shape whose thickness direction is along the front-rear direction. As illustrated in FIG. 8, mating inner shield 72 integrally includes mating base 721, a plurality of (a pair of) first mating protrusions 722, and a plurality of (a pair of) second mating protrusions 723.

Mating base 721 has a plate shape long in the left-right direction.

First mating protrusion 722 protrudes downward from mating base 721. The pair of first mating protrusions 722 is provided at symmetrical positions in the left-right direction at a lower end of mating base 721.

Second mating protrusion 723 protrudes downward from mating base 721. Second mating protrusion 723 is disposed outside first mating protrusion 722 in the left-right direction. The pair of second mating protrusions 723 is provided at symmetrical positions in the left-right direction at the lower end of mating base 721.

As illustrated in FIGS. 9 and 10, in mating inner shield 72, mating base 721 is accommodated in mating accommodation hole 5120 of mating outer bottom wall 512 of mating housing 5, the pair of first mating protrusions 722 is accommodated in the pair of first mating accommodation grooves 5311 of mating holding wall part 53, and the pair of second mating protrusions 723 is press-fitted into the pair of second mating accommodation grooves 5312 (see FIG. 8) of mating holding wall part 53 and is held by mating housing 5.

As illustrated in FIG. 9, first mating predetermined terminal 61 is surrounded by mating outer shield 71 (the pair of first mating outer shields 711 and second mating outer shield 712 on the front side) and mating inner shield 72 on the front side. Second mating predetermined terminal 62 is surrounded by mating outer shield 71 (the pair of first mating outer shields 711 and second mating outer shield 712 on the rear side) and mating inner shield 72 on the rear side. The plurality of mating connection terminals 63 are surrounded by mating outer shield 71 (the pair of first mating outer shields 711) and two mating inner shields 72.

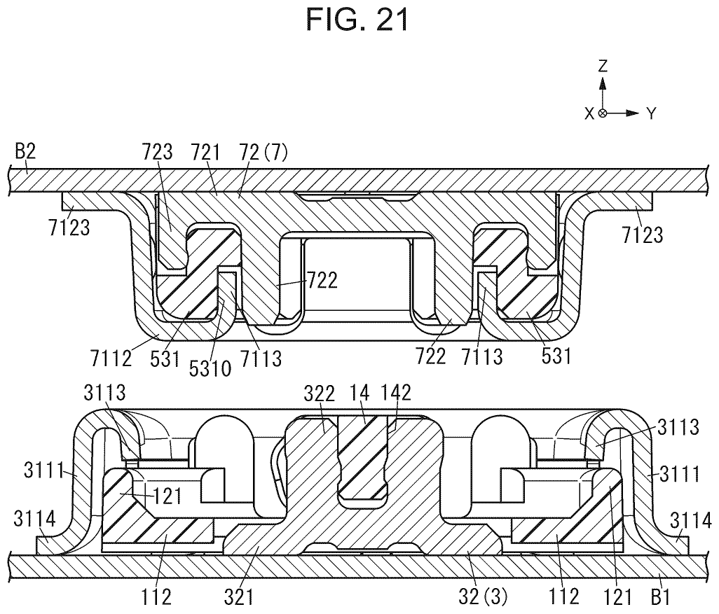

As illustrated in FIG. 21, mating inner shield 72 on the front side is aligned in the left-right direction with additional extension part 7113 on the front side of one first mating outer shield 711 and additional extension part 7113 on the front side of other first mating outer shield 711. More specifically, additional extension part 7113 on the front side of first mating outer shield 711 on the left side, mating inner shield 72 on the front side, and additional extension part 7113 on the front side of first mating outer shield 711 on the right side are aligned on a straight line. As a result, the electromagnetic shielding properties of mating shield 7 are improved. Similarly, mating inner shield 72 on the rear side is aligned in the left-right direction with additional extension part 7113 on the rear side of one first mating outer shield 711 and additional extension part 7113 on the rear side of other first mating outer shield 711. More specifically, additional extension part 7113 on the rear side of first mating outer shield 711 on the left side, mating inner shield 72 on the rear side, and additional extension part 7113 on the rear side of first mating outer shield 711 on the right side are aligned on a straight line. As a result, the electromagnetic shielding properties of mating shield 7 are improved.

Mating inner shield 72 is connected to mating circuit board B2. Mating base 721 of mating inner shield 72 is fixed and electrically connected to a ground pattern of mating circuit board B2 by, for example, soldering or the like. As a result, mating outer shield 71 and mating inner shield 72 have the same potential.

### (1.4) Connection of Connector and Mating Connector

Connection between connector C1 and mating connector C2 will be described with reference to FIGS. 1, 2, and 12 to 22.

As illustrated in FIGS. 12 to 22, connector C1 is mounted on an upper surface of circuit board B1. Mating connector C2 is mounted on a lower surface of mating circuit board B2. In this state, for example, as illustrated in FIGS. 2, 12, 14, 17, 19, and 21, connector C1 is disposed below mating connector C2 (a disconnected state where connector C1 and mating connector C2 are not connected). Connector C1 is moved upward relative to mating connector C2, and thus, connector C1 and mating connector C2 are electrically and mechanically connected (the connected state between connector C1 and mating connector C2) as illustrated in FIGS. 1, 13, 15, 18, 20, and 22.

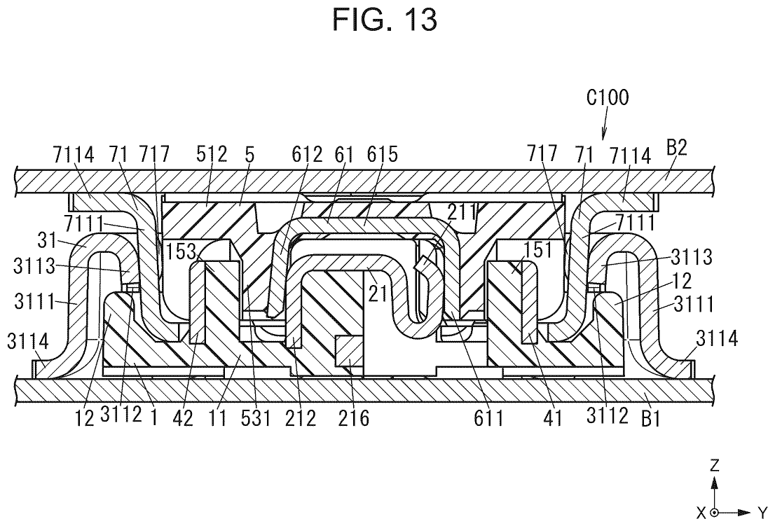

At the time of transition from the disconnected state to the connected state, as illustrated in FIGS. 12 and 13, first contact part 211 of first predetermined terminal 21 is pressed by first mating contact part 611 of first mating predetermined terminal 61, and thus, first coupling part 215 of first predetermined terminal 21 is elastically deformed. As a result, first contact part 211 moves rightward. In the connected state, as illustrated in FIG. 13, first contact part 211 and second contact part 212 of first predetermined terminal 21 come into contact with first mating contact part 611 and second mating contact part 612 of first mating predetermined terminal 61, respectively, and thus, first predetermined terminal 21 and first mating predetermined terminal 61 are electrically connected. At this time, first contact part 211 elastically comes into contact with first mating contact part 611 by an elastic return force of first coupling part 215 to return to an original shape.

Similarly, at the time of transition from the disconnected state to the connected state, first coupling part 225 of second predetermined terminal 22 is elastically deformed. In the connected state, first contact part 221 and second contact part 222 of second predetermined terminal 22 come into contact with first mating contact part 621 and second mating contact part 622 of second mating predetermined terminal 62, respectively, and thus, second predetermined terminal 22 and second mating predetermined terminal 62 are electrically connected.

At the time of transition from the disconnected state to the connected state, as illustrated in FIGS. 14 to 16, fourth contact part 232 of connection terminal 23 is pressed by fourth mating contact part 632 of mating connection terminal 63, and thus, first coupling part 234 of connection terminal 23 is elastically deformed. As a result, fourth contact part 232 moves inward in the left-right direction. In the connected state, as illustrated in FIG. 16, third contact part 231 and fourth contact part 232 of connection terminal 23 come into contact with third mating contact part 631 and fourth mating contact part 632 of mating connection terminal 63, respectively, and thus, connection terminal 23 and mating connection terminal 63 are electrically connected. At this time, fourth contact part 232 elastically comes into contact with fourth mating contact part 632 by an elastic return force of first coupling part 234 to return to an original shape.

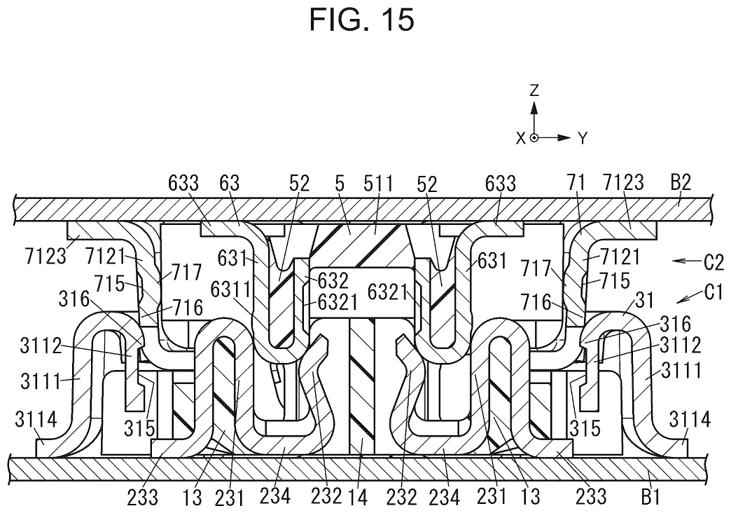

At the time of transition from the disconnected state to the connected state, as illustrated in FIGS. 12 to 16, first extension part 3112 and second extension part 3113 of first outer shield 311 come into contact with mating outer wall 7111 of first mating outer shield 711. Here, at the time of transition from the disconnected state to the connected state, for example, mating connector C2 is moved downward toward connector C1 from above, and thus, mating insertion part 716 of first mating outer shield 711 first comes into contact with insertion part 316 of first outer shield 311 from above (see FIG. 15). When mating connector C2 is further moved downward from this state, mating insertion part 716 and insertion part 316 are pressed against each other, and thus, first extension part 3112 including insertion part 316 is easily elastically deformed outward in the left-right direction. When mating connector C2 is further moved downward and mating insertion part 716 of first mating outer shield 711 reaches a position of recess 315 of first outer shield 311, a force with which mating insertion part 716 and insertion part 316 are pressed against each other becomes weak or the force with which these parts are pressed against each other is not generated, and first extension part 3112 returns inward by an elastic return force. At this time, simultaneously, mating insertion part 716 of first mating outer shield 711 enters recess 315 of first outer shield 311, and insertion part 316 of first outer shield 311 enters mating recess 715 of first mating outer shield 711. By doing this, in the connected state, insertion part 316 is disposed in mating recess 715, and mating insertion part 716 is disposed in recess 315 (see FIG. 16).

In connector set C100 of the present exemplary embodiment, insertion part 316 of first outer shield 311 is formed not in outer wall 3111 but in first extension part 3112. Thus, when connector C1 and mating connector C2 are connected, outer wall 3111 is less likely to be deformed. Thus, in the connected state, it is difficult to form a gap between first outer shield 311 and first mating outer shield 711. As a result, the electromagnetic shielding properties in the connected state can be improved.

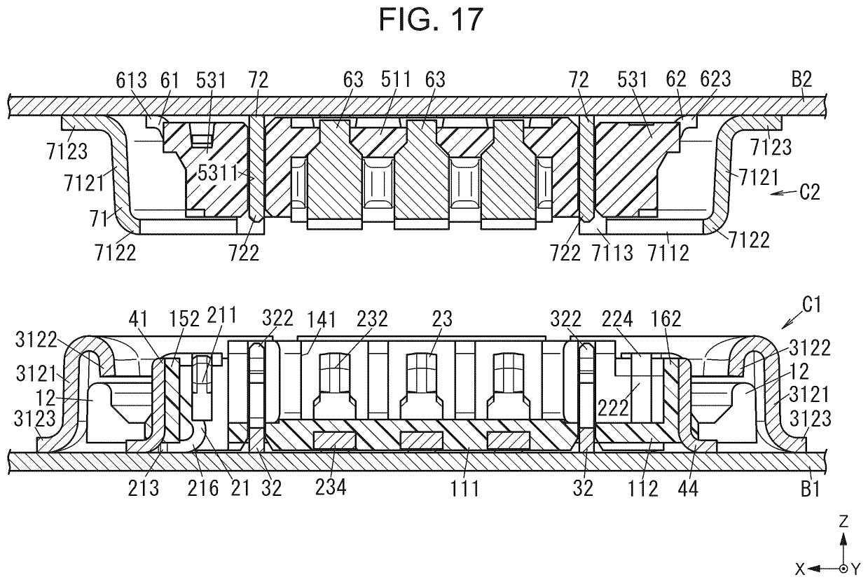

At the time of transition from the disconnected state to the connected state, as illustrated in FIGS. 17 to 20, extension part 3122 of second outer shield 312 and mating outer wall 7121 of second mating outer shield 712 come into contact with each other. As a result, in the connected state, outer shield 31 and mating outer shield 71 are electrically connected.

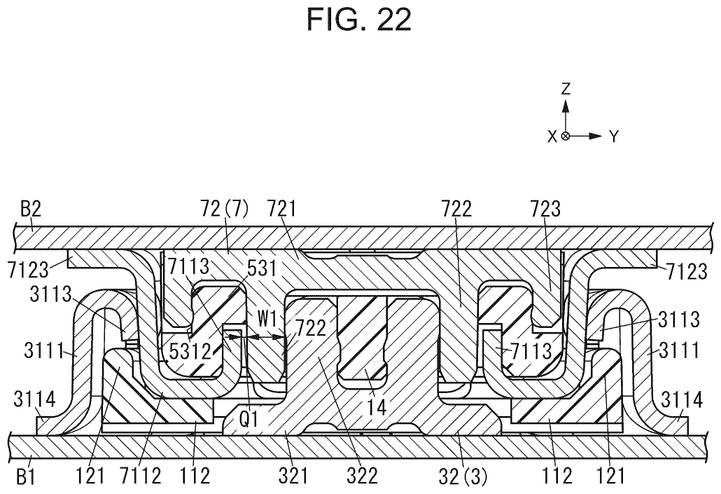

At the time of transition from the disconnected state to the connected state, as illustrated in FIGS. 21 and 22, the pair of protrusions 322 of inner shield 32 and the pair of first mating protrusions 722 of mating inner shield 72 come into contact with each other. As a result, in the connected state, inner shield 32 and mating inner shield 72 are electrically connected.

### (1.5) Connected State

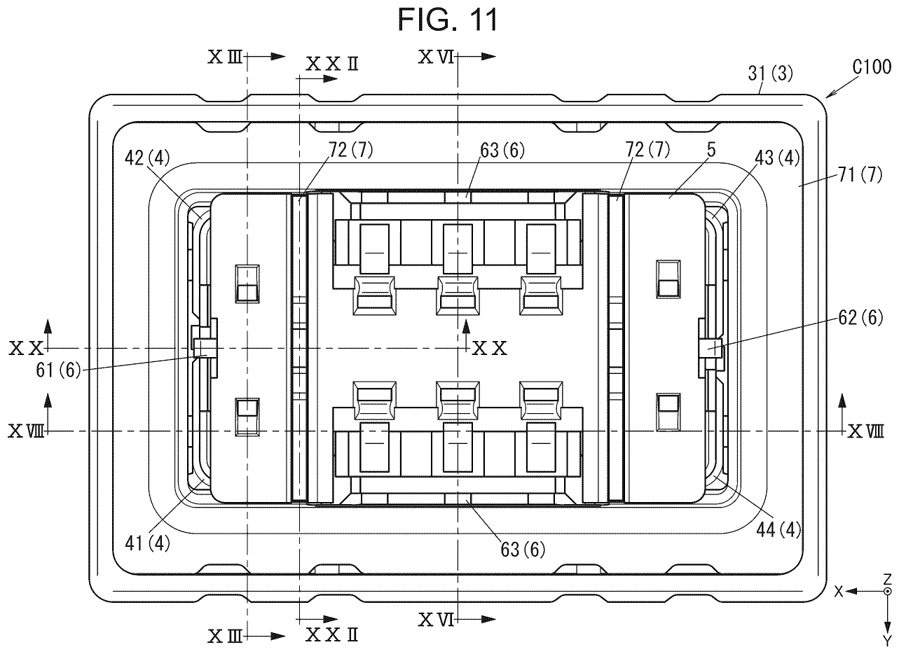

In the connected state where connector C1 and mating connector C2 are connected (see FIGS. 1, 11, 13, 16, 18, and 20), for example, relatively high-frequency signals can be transmitted between circuit board B1 and mating circuit board B2 via first predetermined terminal 21 and first mating predetermined terminal 61. Relatively high-frequency signals can be transmitted via second predetermined terminal 22 and second mating predetermined terminal 62. Relatively low-frequency signals can be transmitted via connection terminal 23 and mating connection terminal 63.

In the connected state, insertion part 316 is disposed in mating recess 715, and mating insertion part 716 is disposed in recess 315 (see FIG. 16). As a result, an external force required to separate connector C1 and mating connector C2 from the connected state increases. Thus, mating outer shield 71 is hardly detached from outer shield 31. That is, a removal force when connector C1 and mating connector C2 in the connected state are separated and the transition to the non-connected state is performed is improved (increased). In short, in connector set C100 of the present exemplary embodiment, first outer shield 311 has recess 315 and insertion part 316 and first mating outer shield 711 has mating recess 715 and mating insertion part 716, and thus, the removal force can be improved (increased).

Insertion part 316 is disposed in mating recess 715 and mating insertion part 716 is disposed in recess 315, and thus, the electromagnetic shielding properties can be improved.

A click feeling is generated when mating insertion part 716 is disposed in recess 315 and when insertion part 316 is disposed in mating recess 715. With this click feeling, it is possible to recognize that connector C1 and mating connector C2 are in the connected state.

In connector set C100 of the present exemplary embodiment, recess 315 is formed to extend in the front-rear direction to face first terminal 201 and second terminal 202 in the left-right direction. Recess 315 and insertion part 316 are formed from front end 3118 to rear end 3119 of first extension part 3112. Front end 3118 and rear end 3119 of first extension part 3112 have holding part 3117 held by housing 1. With these configurations, the removal force can be improved.

As illustrated in FIG. 16, in connector set C100 of the present exemplary embodiment, insertion part 316 includes curved surface 3116 of first extension part 3112. As a result, connector C1 can be downsized. At the time of transition from the disconnected state to the connected state, mating insertion part 716 can be smoothly moved along curved surface 3116 of insertion part 316.

In connector C1 of the present exemplary embodiment, slit 3115 is formed between first extension part 3112 and second extension part 3113, but slit 3115 is not formed in outer wall 3111. In other words, front end 3118 and rear end 3119 of first extension part 3112 are formed from the uppermost end of the coupling part between outer wall 3111 and first extension part 3112. According to this configuration, the deformation of outer wall 3111 is suppressed when connector C1 and mating connector C2 are connected. That is, since the slit is not formed even in outer wall 3111, it is possible to prevent outer wall 3111 from being curved outward when connector C1 and mating connector C2 are connected. As a result, it is possible to suppress the formation of a gap between first outer shield 311 and first mating outer shield 711. As a result, the electromagnetic shielding properties in the connected state can be improved.

As illustrated in FIG. 16, in connector set C100 of the present exemplary embodiment, insertion part 316 of first outer shield 311 comes into contact with the inner surface of mating recess 715 of first mating outer shield 711 in the connected state. As a result, the electromagnetic shielding properties in the connected state can be improved. Insertion part 316 may come into contact with the inner surface of mating recess 715 of first mating outer shield 711 over the entire length in the front-rear direction.

Recess 315 and insertion part 316 are not formed in second extension part 3113. As a result, the removal force can be adjusted.

As illustrated in FIG. 13, in the connected state, the flat part (inner surface) of the second extension part 3113 comes into contact with the flat part (outer surface of mating outer wall 7111) of first mating outer shield 711. As illustrated in FIG. 18, the flat part (inner surface) of extension part 3122 comes into contact with the flat part (outer surface of the mating outer wall 7121) of the second mating outer shield 712. As described above, in the connected state, outer shield 31 and mating outer shield 71 surround first predetermined terminal 21 and first mating predetermined terminal 61 in three sides of a rectangular shape in a circumferential direction, and come into continuous contact with each other on the three sides. As a result, the electromagnetic shielding properties can be improved.

As illustrated in FIG. 22, in connector set C100 of the present exemplary embodiment, protrusion 322 of inner shield 32 and first mating protrusion 722 of mating inner shield 72 come into contact with each other in the connected state. Protrusion 322 on a left side and first mating protrusion 722 on a left side come into contact with each other, and protrusion 322 on a right side and first mating protrusion 722 on a right side come into contact with each other. An outer side surface of protrusion 322 in the left-right direction and an inner side surface of first mating protrusion 722 in the left-right direction come into contact with each other.

More specifically, as described above, in mating shield 7, additional extension part 7113 on the front side of first mating outer shield 711 on the left side, mating inner shield 72 on the front side, and additional extension part 7113 on the front side of first mating outer shield 711 on the right side are aligned on a straight line. As illustrated in FIG. 22, in the connected state, the pair of protrusions 322 of inner shield 32 on the front side are further aligned on a straight line with a pair of additional extension parts 7113 and mating inner shield 72. As illustrated in FIG. 22, in the connected state, a void is formed between protrusion 322 and the additional extension part 7113 in the left-right direction. In the left-right direction, interval Q1 of the void between protrusion 322 and additional extension part 7113 is smaller than width W1 of protrusion 322 in the left-right direction. As a result, the electromagnetic shielding properties can be improved.

Similarly, in mating shield 7, additional extension part 7113 on the rear side of first mating outer shield 711 on the left side, mating inner shield 72 on the rear side, and additional extension part 7113 on the rear side of first mating outer shield 711 on the right side are aligned on a straight line. In the connected state, the pair of protrusions 322 of inner shield 32 on the rear side are further aligned on a straight line with the pair of additional extension parts 7113 and mating inner shield 72. As a result, the electromagnetic shielding properties can be improved.

### (2) Modifications

The exemplary embodiment described above is merely one of various exemplary embodiments of the present disclosure. The exemplary embodiment described above can be variously changed according to a design and the like as long as the object of the present disclosure can be achieved. Hereinafter, modifications of the exemplary embodiment will be listed. The exemplary embodiment described above and the modifications to be described below can be applied in appropriate combination. In the following description of each modification, the description of the same configuration as the above exemplary embodiment may be appropriately omitted.

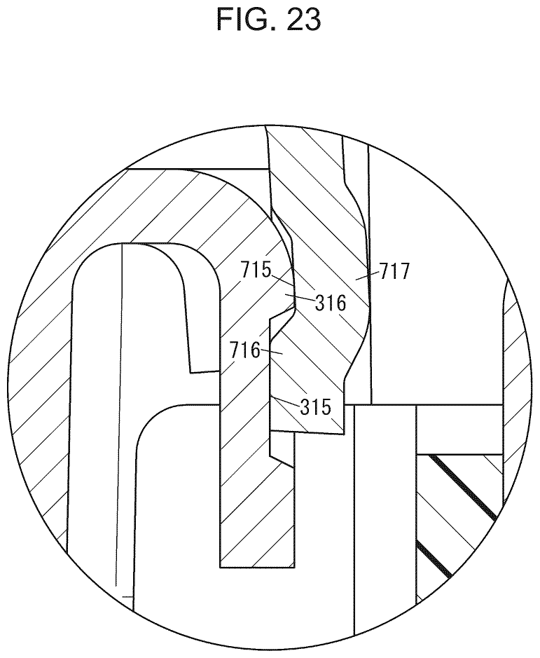

In one modification, as illustrated in FIG. 23, in a connected state, mating insertion part 716 of first mating outer shield 711 may be in contact with an inner surface of recess 315 of first outer shield 311. Mating insertion part 716 may come into contact with the inner surface of recess 315 of first outer shield 311 over the entire length in a front-rear direction. In this case, insertion part 316 of first outer shield 311 may not come into contact with an inner surface of mating recess 715 of first mating outer shield 711. From a viewpoint of electromagnetic shielding properties, at least one state of a state where insertion part 316 comes into contact with the inner surface of mating recess 715 and a state where mating insertion part 716 comes into contact with the inner surface of recess 315 is preferable. As illustrated in FIG. 23, both the state where insertion part 316 comes into contact with the inner surface of mating recess 715 and the state where mating insertion part 716 comes into contact with the inner surface of recess 315 may be adopted. A contact state between a set of first outer shield 311 and first mating outer shield 711 on a right side and a contact state between a set of first outer shield 311 and first mating outer shield 711 on a left side may be different. For example, in the set on the right side, insertion part 316 may come into contact with the inner surface of mating recess 715 and mating insertion part 716 may not come into contact with the inner surface of recess 315, and in the set on the left side, insertion part 316 may not come into contact with the inner surface of mating recess 715 and mating insertion part 716 may come into contact with the inner surface of recess 315.

In one modification, slit 3115 may not be formed from an uppermost end of a coupling part between outer wall 3111 and first extension part 3112. Slit 3115 may be formed from a position inside the uppermost end of the coupling part in the left-right direction.

In one modification, outer shield 31 does not necessarily need to seamlessly surround the plurality of terminals 2, and there may be a gap. The same applies to mating outer shield 71.

### (3) Aspects

As is apparent from the above-described exemplary embodiment and modifications, the following aspects are disclosed in the present specification.

Connector set (C100) of a first aspect includes connector (C1) and mating connector (C2). Connector (C1) is connected to mating connector (C2) by moving upward relative to mating connector (C2). Connector (C1) includes housing (1), a plurality of terminals (2), and outer shield (31). The plurality of terminals (2) are held by housing (1). The plurality of terminals (2) include first terminal (201). Outer shield (31) is held by housing (1). Outer shield (31) surrounds first terminal (201). Mating connector (C2) includes mating housing (5), a plurality of mating terminals (6), and mating outer shield (71). The plurality of mating terminals (6) are held by mating housing (5). The plurality of mating terminals (6) are electrically connected to the plurality of terminals (2). The plurality of mating terminals (6) include first mating terminal (601) electrically connected to first terminal (201). Mating outer shield (71) is held by mating housing (5). Outer shield (31) includes first outer shield (311) facing first terminal (201) in a left-right direction. Mating outer shield (71) includes first mating outer shield (711) facing first mating terminal (601) in the left-right direction. First outer shield (311) includes recess (315) recessed outward of connector (C1) in the left-right direction, and insertion part (316) formed above recess (315) and continuous with an upper surface of recess (315). First mating outer shield (711) is recessed inward of mating connector (C2) in the left-right direction, and includes mating recess (715) in which insertion part (316) is disposed in a connected state where connector (C1) and mating connector (C2) are connected, and mating insertion part (716) disposed below mating recess (715) and disposed in recess (315) in the connected state.

According to this aspect, the removal force can be improved.

In connector set (C100) of a second aspect, in the first aspect, first outer shield (311) includes outer wall (3111) and an extension part (first extension part 3112) curved inward of connector (C1) from an upper end of outer wall (3111). Insertion part (316) is disposed in the extension part.

According to this aspect, deformation of outer wall (3111) of first outer shield (311) is suppressed when connector (C1) and mating connector (C2) are connected. As a result, it is possible to suppress formation of a gap between first outer shield (311) and first mating outer shield (711) in the connected state. As a result, the electromagnetic shielding properties in the connected state can be improved.

In connector set (C100) of a third aspect, in the second aspect, insertion part (316) includes curved surface (3116) of the extension part (first extension part 3112).

According to this aspect, connector (C1) can be downsized as compared with a case where insertion part (316) does not include curved surface (3116) of the extension part (first extension part 3112).

In connector set (C100) of a fourth aspect, in the second or third aspect, the extension part (first extension part 3112) has front end (3118) and rear end (3119) at both ends in a front-rear direction. Recess (315) and insertion part (316) are disposed from front end (3118) to rear end (3119) of the extension part.

According to this aspect, the removal force can be improved.

In connector set (C100) of a fifth aspect, in any one of the second to fourth aspects, the extension part (first extension part 3112) has front end (3118) and rear end (3119) at both ends in a front-rear direction. Front end (3118) and rear end (3119) of the extension part have holding part (3117) held by housing (1).

According to this aspect, the removal force can be improved.

In connector set (C100) according to a sixth aspect, in any one aspect of the first to fifth aspects, the plurality of terminals (2) further include second terminal (202) aligned in a front-rear direction with first terminal (201) and facing first outer shield (311) in the left-right direction. Recess (315) is disposed to extend in the front-rear direction to face first terminal (201) and second terminal (202) in the left-right direction.

According to this aspect, the removal force can be improved.

In connector set (C100) of a seventh aspect, in any one aspect of the first to sixth aspects, first outer shield (311) includes outer wall (3111) and an extension part (first extension part 3112) that is curved inward of connector (C1) from an upper end of outer wall (3111). The extension part has front end (3118) and rear end (3119) at both ends in a front-rear direction. Front end (3118) and rear end (3119) are disposed from an uppermost end of a coupling part between outer wall (3111) and the extension part.

According to this aspect, deformation of outer wall (3111) of first outer shield (311) is suppressed when connector (C1) and mating connector (C2) are connected. As a result, it is possible to suppress formation of a gap between first outer shield (311) and first mating outer shield (711), and the electromagnetic shielding properties can be improved.

In connector set (C100) of an eighth aspect, in the seventh aspect, the extension part is first extension part (3112). First outer shield (311) further includes second extension part (3113) curved inward of connector (C1) from an upper end of outer wall (3111) and aligned with the first extension part in the front-rear direction. Slit (3115) is disposed between first extension part (3112) and second extension part (3113).

According to this aspect, the electromagnetic shielding properties can be improved.

In connector set (C100) of a ninth aspect, in any one aspect of the first to eighth aspects, outer shield (31) surrounds the plurality of terminals (2).

According to this aspect, the electromagnetic shielding properties can be improved.

In connector set (C100) according to a tenth aspect, in any one aspect of the first to ninth aspects, mating outer shield (71) surrounds the plurality of mating terminals (6).

According to this aspect, the electromagnetic shielding properties can be improved.

In connector set (C100) according to an eleventh aspect, in any one aspect of the first to tenth aspects, in the connected state, insertion part (316) of first outer shield (311) comes into contact with an inner surface of mating recess (715) of first mating outer shield (711).

According to this aspect, the electromagnetic shielding properties can be improved.

In connector set (C100) according to a twelfth aspect, in any one aspect of the first to eleventh aspects, in the connected state, mating insertion part (716) of first mating outer shield (711) comes into contact with an inner surface of recess (315) of first outer shield (311).

According to this aspect, the electromagnetic shielding properties can be improved.

In connector set (C100) according to a thirteenth aspect, in any one aspect of the first to twelfth aspects, first mating outer shield (711) has mating projection (717) protruding inward of mating connector (C2) on a back side of mating recess (715).

According to this aspect, the strength of first mating outer shield (711) can be secured.

What is claimed is:

1. A connector set comprising:
a connector; and
a mating connector,
wherein
the connector is connected to the mating connector by moving upward relative to the mating connector,
the connector includes
a housing,
a plurality of terminals that are held by the housing and include a first terminal, and
an outer shield that is held by the housing and surrounds the first terminal,
the mating connector includes
a mating housing,
a plurality of mating terminals that are held by the mating housing, include a first mating terminal electrically connected to the first terminal, and are electrically connected to the plurality of terminals, and
a mating outer shield that is held by the mating housing,
the outer shield includes a first outer shield facing the first terminal in a left-right direction,
the mating outer shield includes a first mating outer shield facing the first mating terminal in the left-right direction,
the first outer shield includes
a recess recessed outward of the connector in the left-right direction, and
an insertion part disposed above the recess and continuous with an upper surface of the recess, and
the first mating outer shield includes
a mating recess recessed inward of the mating connector in the left-right direction, the insertion part being disposed in the mating recess in a connected state where the connector and the mating connector are connected, and
a mating insertion part disposed below the mating recess and disposed in the recess in the connected state.

2. The connector set according to claim 1, wherein
the first outer shield includes
an outer wall, and
an extension part curved inward of the connector from an upper end of the outer wall, and
the insertion part is disposed in the extension part.

3. The connector set according to claim 2, wherein the insertion part includes a curved surface of the extension part.

4. The connector set according to claim 2, wherein
the extension part has a front end and a rear end at both ends in a front-rear direction, and
the recess and the insertion part are disposed from the front end to the rear end of the extension part.

5. The connector set according to claim 2, wherein
the extension part has a front end and a rear end at both ends in a front-rear direction, and
the front end and the rear end of the extension part include a holding part held by the housing.

6. The connector set according to claim 1, wherein
the plurality of terminals further include a second terminal aligned with the first terminal in a front-rear direction and facing the first outer shield in the left-right direction, and
the recess is disposed to extend in the front-rear direction to face the first terminal and the second terminal in the left-right direction.

7. The connector set according to claim 1, wherein
the first outer shield includes
an outer wall, and
an extension part curved inward of the connector from an upper end of the outer wall,
the extension part has a front end and a rear end at both ends in a front-rear direction, and
the front end and the rear end are disposed from an uppermost end of a coupling part between the outer wall and the extension part.

8. The connector set according to claim 7, wherein
the extension part is a first extension part,
the first outer shield further includes a second extension part curved inward of the connector from the upper end of the outer wall and aligned with the first extension part in the front-rear direction, and
a slit is disposed between the first extension part and the second extension part.

9. The connector set according to claim 1, wherein the outer shield surrounds the plurality of terminals.

10. The connector set according to claim 1, wherein the mating outer shield surrounds the plurality of mating terminals.

11. The connector set according to claim 1, wherein, in the connected state, the insertion part of the first outer shield comes into contact with an inner surface of the mating recess of the first mating outer shield.

12. The connector set according to claim 1, wherein, in the connected state, the mating insertion part of the first mating outer shield comes into contact with an inner surface of the recess of the first outer shield.

13. The connector set according to claim 1, wherein the first mating outer shield includes a mating projection protruding inward of the mating connector on a back side of the mating recess.
